(19) United States
(12) Patent Application Publication
(10) Pub. No.: US 2013/0046929 A1
(43) Pub. Date: Feb. 21, 2013

(54) INTERFACE MODULE, COMMUNICATION APPARATUS, AND COMMUNICATION METHOD

(71) Applicant: Yasuyuki Mitsumori, Kawasaki (JP)

(72) Inventor: Yasuyuki Mitsumori, Kawasaki (JP)

(73) Assignee: FUJITSU LIMITED, Kawasaki-shi (JP)

(21) Appl. No.: 13/555,775

(22) Filed: Jul. 23, 2012

(30) Foreign Application Priority Data
Aug. 18, 2011 (JP) 2011-179186

(51) Int. Cl. G06F 12/00

(52) U.S. Cl. 711/108

(57) ABSTRACT

An interface module includes ports; a first memory that stores identifiers indicating processing operations for data blocks associating with the ports; a content-addressable memory that stores keys, each including at least one port and one identifier; a second memory that stores processing information associated with the keys and indicating processing operations for data blocks; an action code circuit that, when a data block has been received, obtains, from the first memory, an identifier set for a port that has received the data block; a generation circuit that generates a key from the port that has received the data block and the identifier obtained by the action code circuit; and a judgment circuit that judges how to process the received data block in accordance with a piece of the processing information associated with the generated key obtained by searching the content-addressable memory using the key generated by the generation circuit.

### CROSS-REFERENCE TO RELATED APPLICATION(S)

This application is based upon and claims the benefit of priority of the prior Japanese Patent Application No. 2011-179186, filed on Aug. 18, 2011, the entire contents of which are incorporated herein by reference.

### FIELD

The embodiments discussed herein are related to an interface module, a communication apparatus, and a communication method.

### BACKGROUND

Currently, as the Internet and mobile networks become more and more popular, packet-switched networks are used more frequently in which an Ethernet (registered trademark) technology or an Internet Protocol (IP) technology is utilized for carrier networks. In the following description, “packets” and “frames” will be used as synonyms.

In a communication apparatus used in a packet-switched network such as an IP network or an Ethernet network, a control frame and a user frame coexist in the same physical port. A control frame is a frame that is terminated by a communication apparatus that has received the control frame. A user frame is a frame that is transferred to a network by a communication apparatus that has received the user frame. Upon receiving a frame, a communication apparatus judges the type of frame received and, for example, discards, terminates, or transfers the received frame. Such a judgment of the type of frame and a process such as discard, termination, or transfer based on the type of frame are called “packet filtering”.

As examples of the related art, for example, International Publication Pamphlet No. WO2005/015851, Japanese Laid-open Patent Publication No. 8-18593, Japanese Laid-open Patent Publication No. 2002-271396, Japanese Laid-open Patent Publication No. 2000-332817, and Japanese Laid-open Patent Publication No. 2002-335275 have been disclosed.

### SUMMARY

According to an aspect of the invention, an interface module includes ports; a first memory that stores identifiers indicating processing operations for data blocks while associating the identifiers with the ports; a content-addressable memory that stores keys, each including at least one port and one identifier; a second memory that stores processing information associated with the keys held by the content-addressable memory and indicating processing operations for data blocks in accordance with the processing operation indicated by the at least one identifier included in one of the keys with which a piece of the processing information is associated; an action code circuit that, when a data block has been received, obtains, from the first memory, an identifier set for a port that has received the data block; a generation circuit that generates a key from the port that has received the data block and the identifier obtained by the action code circuit; and a judgment circuit that judges how to process the received data block in accordance with a piece of the processing information associated with the generated key obtained by searching the content-addressable memory using the key generated by the generation circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a network;

FIG. 2 is a diagram illustrating an example of a communication apparatus;

FIG. 3 is a diagram illustrating the formats of Ethernet frames;

FIG. 4 is a diagram illustrating an example of an Ethernet frame to which an apparatus header to be used in the communication apparatus has been added;

FIG. 5 is a diagram illustrating an example of a frame reception side of a line interface (IF) circuit;

FIG. 6 is a diagram illustrating an example of entries in a content-addressable memory;

FIG. 7 is a diagram illustrating an example of entries stored in an associative memory;

FIG. 8 is a diagram illustrating an example of a line IF circuit according to a first embodiment;

FIG. 9 is a diagram illustrating an example of entries in a port action code (AC) table according to the first embodiment;

FIG. 10 is a diagram illustrating an example of entries in a content-addressable memory according to the first embodiment;

FIG. 11 is a diagram illustrating an example of entries in an associative memory according to the first embodiment;

FIG. 12 is a flowchart illustrating a process for receiving a frame executed by the line IF circuit according to the first embodiment;

FIG. 13 is a diagram illustrating an example of entries in a port AC table according to a second embodiment;

FIG. 14 is a diagram illustrating an example of entries in a content-addressable memory according to the second embodiment;

FIG. 15 is a diagram illustrating an example of entries in an associative memory according to the second embodiment;

FIG. 16 is a diagram illustrating an example of entries in a port AC table according to a third embodiment;

FIG. 17 is a diagram illustrating an example of entries in a content-addressable memory according to the third embodiment;

FIG. 18 is a diagram illustrating an example of entries in an associative memory according to the third embodiment;

FIG. 19 is a diagram illustrating an example of entries in an associative memory according to a fourth embodiment;

FIG. 20 is a diagram illustrating an example of a line IF circuit according to a fifth embodiment;

FIG. 21 is a diagram illustrating an example of a statistical information table according to the fifth embodiment;

FIG. 22 is a diagram illustrating an example of entries in an associative memory according to a sixth embodiment;

FIG. 23 is a diagram illustrating an example of a statistical information table according to the sixth embodiment;

FIG. 24 is a diagram illustrating an example of a line IF circuit according to a seventh embodiment;

FIG. 25 is a diagram illustrating an example of entries in an associative memory according to a seventh embodiment;

FIG. 26 is a diagram illustrating an example of entries in a port AC table according to a seventh embodiment;

FIG. 27 is a flowchart illustrating an example of an AC filtering judgment process executed on a frame received by an AC filtering circuit;

FIG. 28A is a flowchart illustrating an example of a process for receiving a frame executed by the line IF circuit according to the seventh embodiment;

FIG. 28B is a flowchart illustrating an example of the process for receiving a frame executed by the line IF circuit according to the seventh embodiment;

FIG. 29 is a diagram illustrating an example of a line IF circuit according to an eighth embodiment;

FIG. 30 is a diagram illustrating an example of a virtual local area network (VLAN) AC table according to the eighth embodiment;

FIG. 31 is a flowchart illustrating an example of an AC filtering judgment process executed by an AC filtering circuit according to the eighth embodiment;

FIG. 32 is a diagram illustrating an example of a line IF circuit according to a ninth embodiment;

FIG. 33A is a flowchart illustrating an example of an AC filtering judgment process executed by an AC filtering circuit according to the ninth embodiment;

FIG. 33B is a flowchart illustrating an example of the AC filtering judgment process executed by the AC filtering circuit according to the ninth embodiment;

FIG. 34 is a diagram illustrating the format of an Ethernet frame to which an apparatus header according to a tenth embodiment has been added;

FIG. 35 is a diagram illustrating an example of a port AC table according to the tenth embodiment;

FIG. 36 is a diagram illustrating an example of a VLAN AC table according to the tenth embodiment;

FIG. 37A is a flowchart illustrating an example of an AC filtering judgment process executed by an AC filtering circuit according to the tenth embodiment;

FIG. 37B is a flowchart illustrating an example of the AC filtering judgment process executed by the AC filtering circuit according to the tenth embodiment;

FIG. 38 is a flowchart illustrating an example of a process for transmitting a frame executed by a line IF circuit according to the tenth embodiment;

FIG. 39 is a diagram illustrating an example of the format of an Ethernet frame to which an apparatus header according to an eleventh embodiment has been added;

FIG. 40 is a flowchart illustrating an example of a process for transmitting a frame executed by a line IF circuit according to the eleventh embodiment;

FIG. 41 is a diagram illustrating an example of a line IF circuit according to a twelfth embodiment;

FIG. 42 is a flowchart illustrating an example of a process for receiving a frame executed by the line IF circuit according to the twelfth embodiment; and

FIG. 43 is a flowchart illustrating an example of a process for transmitting a frame executed by the twelfth embodiment.

### DESCRIPTION OF EMBODIMENTS

Embodiments will be described hereinafter with reference to the drawings. The configurations of the following embodiments are examples, and therefore the present disclosure is not limited by the configurations of the embodiments.

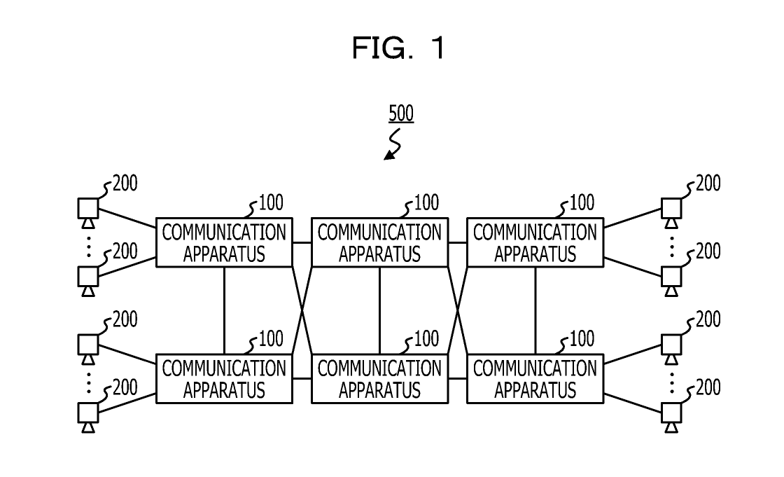

FIG. 1 is a diagram illustrating an example of the configuration of a network. A network 500 includes a plurality of communication apparatuses 100 and a plurality of user terminals 200. A user terminal 200 is, for example, a terminal apparatus having a communication function, such as a personal computer, a mobile telephone terminal, a mobile information terminal, or a smartphone. A communication apparatus 100 receives a frame transmitted from the user terminal 200 and executes a process for transferring the frame on the basis of address information or the like stored in the frame. For example, when a user terminal 200 has transmitted an Ethernet frame, the communication apparatus 100 executes the process for transferring the frame on the basis of a Media Access Control (MAC) address stored in the received Ethernet frame as the address information. On the other hand, for example, when the user terminal 200 has transmitted an IP address, the communication apparatus 100 executes the process for transferring the frame on the basis of an IP address stored in the received IP frame as the address information. In the following description, a case will be described in which each communication apparatus 100 executes the process for transferring an Ethernet frame. An Ethernet frame is an example of a data block according to an aspect.

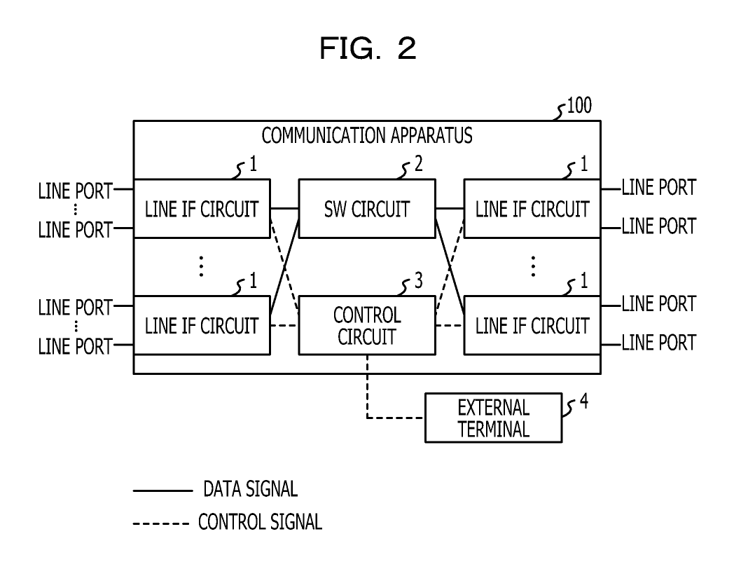

FIG. 2 is a diagram illustrating an example of the communication apparatus 100. The communication apparatus 100 includes a plurality of line IF circuits 1, a switch (SW) circuit 2, and a control circuit 3. A line IF circuit 1 is a circuit that stores line ports and that provides a function of interfacing with external apparatuses, a function of receiving frames, a function of transmitting frames, and the like. The line IF circuit 1 is an example of an interface module according to the aspect. The SW circuit 2 is a circuit that is coupled to the line IF circuits 1 in the communication apparatus 100 by communicating data signals with the line IF circuits 1 and that provides a function of switching frame transfer between the line IF circuits 1. The SW circuit 2 is an example of a switch circuit according to the aspect. The control circuit 3 is coupled to the line IF circuits 1 and the SW circuit 2 in the communication apparatus 100 by communicating control signals with the line IF circuits 1 and the SW circuit 2. The control circuit 3 is a circuit that controls various types of setting of each circuit in the communication apparatus 100, alarms, collection of statistical information, and the like. The control circuit 3 is also coupled to an external terminal 4 such as an external monitor.

The communication apparatus 100 is, for example, a relay apparatus such as a layer 2 switch or a layer 3 switch. For example, the communication apparatus 100 is an apparatus having a relay function. The line IF circuits 1, the SW circuit 2, and the control circuit 3 are, for example, provided as modules or cards that are removably attached to the communication apparatus 100. Alternatively, the line IF circuits 1, the SW circuit 2, and the control circuit 3 may be integrated with a motherboard or a mother card of the communication apparatus 100.

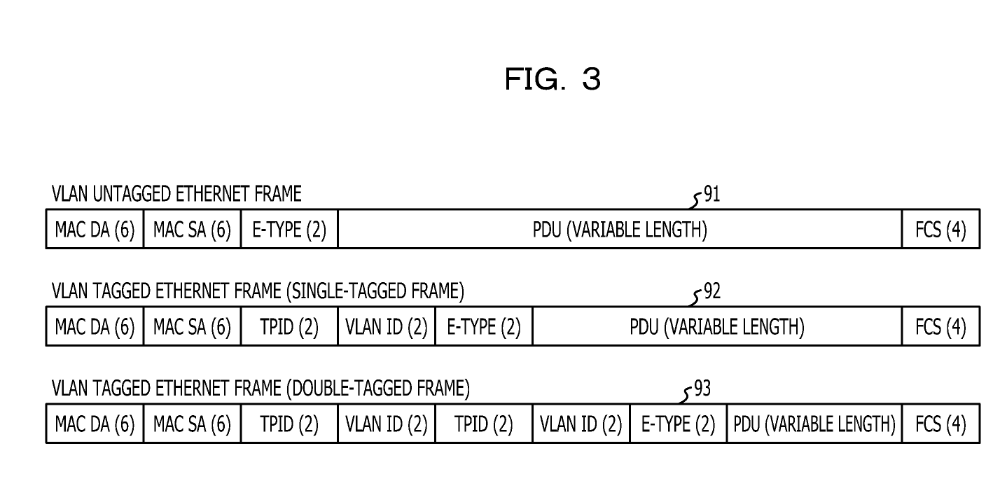

FIG. 3 is a diagram illustrating the formats of Ethernet frames. In FIG. 3, a VLAN untagged Ethernet frame 91, a VLAN single-tagged Ethernet frame 92, and a VLAN double-tagged Ethernet frame 93 are illustrated. The three types of frames may coexist in the same port in the communication apparatus 100.

The format of the VLAN untagged Ethernet frame 91 is as follows. “MAC DA” is a 6-byte field that indicates the MAC address of a destination. “MAC SA” is a 6-byte field that indicates the MAC address of a source. “E-TYPE” is a field that indicates the Ethernet type and that stores the type of message stored in a protocol data unit (PDU) in a later stage. For example, when 0x0800 is stored in “E-TYPE”, the PDU in the later stage stores a packet according to Internet Protocol version 4 (IPv4). “E-TYPE” is a 2-byte field. The type of message stored in “E-TYPE” is defined by the Internet Assigned Numbers Authority (IANA).

The PDU stores a message in an upper layer such as an IPv4 frame. A frame check sequence (FCS) is a 4-byte field that stores a cyclic redundancy check (CRC)-32 code for detecting an error in a frame.

The VLAN single-tagged Ethernet frame 92 is a frame in which a VLAN tag is provided between the MAC SA field and the E-TYPE field of the VLAN untagged Ethernet frame 91. The VLAN tag includes a tag protocol identifier (TPID) and a VLAN identifier (ID). The TPID is one of the Ethernet types and indicates that the VLAN ID is stored in a later stage. For example, 0x8100, which indicates the Institute of Electrical and Electronics Engineers (IEEE) 802.1Q, is set in the TPID. The TPID is a 2-byte field. The VLAN ID stores a VLAN ID value for identifying a user.

VLAN tags can be sequentially stacked. In the VLAN double-tagged Ethernet frame 93, two VLAN tags are sequentially provided.

The VLAN untagged Ethernet frame 91 is, for example, used as a frame for a particular user or as a control frame communicated between the communication apparatuses 100 in a line port in which various Ethernet frames coexist.

A VLAN tagged Ethernet frame is used by providing different VLAN IDs to different users, that is, for example, by providing VLAN ID=100 to User A and VLAN ID=200 to User B. By providing different VLAN IDs to different users, the VLAN tagged Ethernet frame can identify the users in a network using the VLAN IDs.

The VLAN double-tagged Ethernet frame 93 is used, for example, when a frame in a lower network is transferred in a higher network. In this case, the second VLAN tag (the tag closer to the PDU) is used as a user identification tag or a management tag in the lower network. The first VLAN tag (the tag closer to “MAC SA”) is used as a user identification tag or a management tag in the higher network.

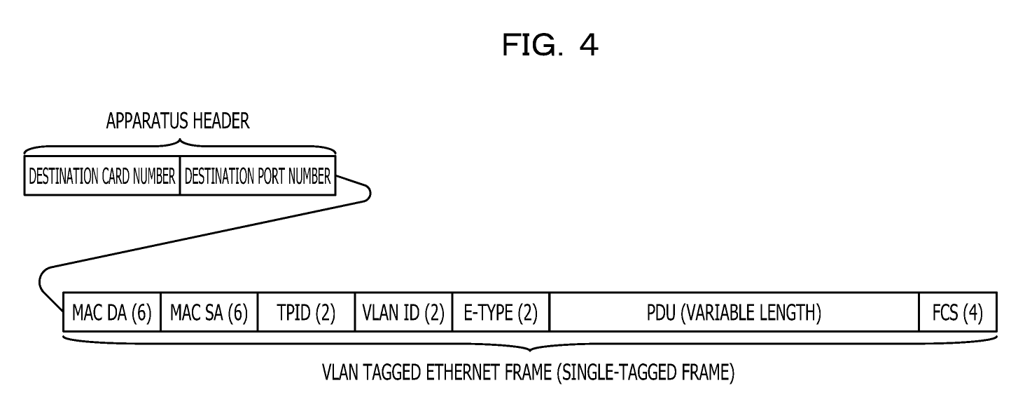

FIG. 4 is a diagram illustrating an example of an Ethernet frame to which an apparatus header to be used in the communication apparatus 100 has been added. Upon receiving a frame, the line IF circuit 1 in the communication apparatus 100 adds an apparatus header including address information in the communication apparatus 100 to the received frame. The apparatus header includes a destination card number and a destination port number as the address information in the communication apparatus 100.

In the communication apparatus 100, a line IF circuit 1 that has received a frame adds an apparatus header to the received frame. The destination card number and the destination port number included in the apparatus header are determined by the line IF circuit 1 that has received the frame on the basis of a destination MAC address included in the received frame (details will be described later). The received frame to which the apparatus header has been added is transferred to the SW circuit 2. The SW circuit 2 transfers the received frame to a line IF circuit 1 indicated by the destination card number included in the apparatus header in accordance with the apparatus header of the received frame. The apparatus header is removed by the line IF circuit 1 indicated by the destination card number included in the apparatus header when the frame is output to a line from a port indicated by the destination card number and the destination port number included in the apparatus header.

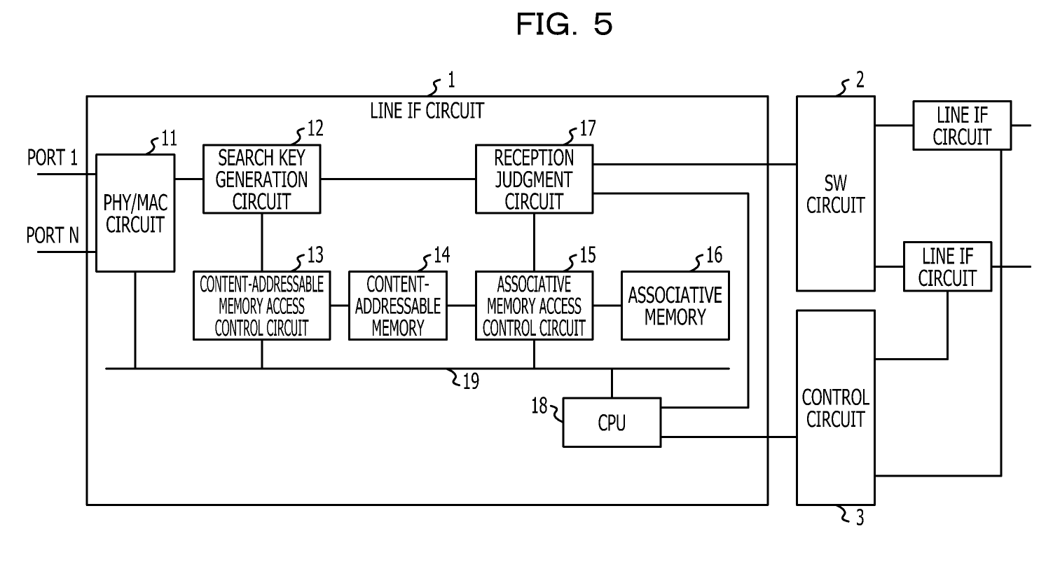

FIG. 5 is a diagram illustrating an example of a frame reception side of the line IF circuit 1. The line IF circuit 1 includes a physical (PHY)/MAC circuit 11, a search key generation circuit 12, a content-addressable memory access control circuit 13, a content-addressable memory 14, an associative memory access control circuit 15, an associative memory 16, a reception judgment circuit 17, and a central processing unit (CPU) 18. The PHY/MAC circuit 11, the content-addressable memory access control circuit 13, the associative memory access control circuit 15, and the CPU 18 are coupled to one another through a control bus 19.

The PHY/MAC circuit 11 executes a process for terminating a received frame in a physical layer and a MAC layer. In the MAC layer, the PHY/MAC circuit 11 executes an FCS check and the like on the received frame and discards an FCS error frame. A frame without an error is transmitted into the communication apparatus 100.

The search key generation circuit 12 obtains, for example, 20-byte data from the top of an Ethernet frame received by the PHY/MAC circuit 11 as a frame without an error. The search key generation circuit 12 generates a search key by combining this 20-byte data and a reception port number. The search key generation circuit 12 then transmits the generated search key to the content-addressable memory access control circuit 13.

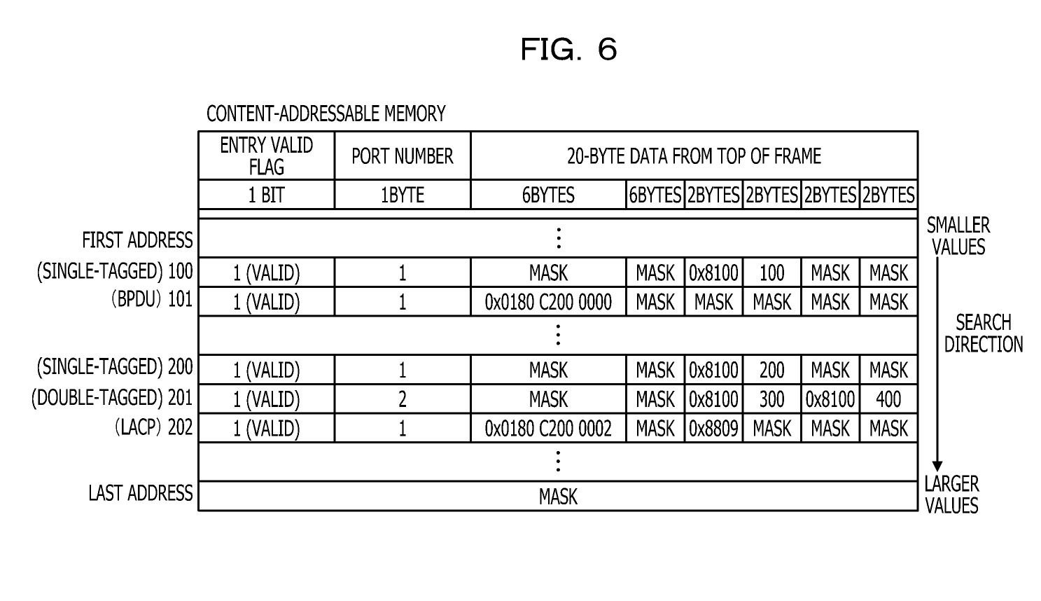

The content-addressable memory access control circuit 13 executes a process for searching the content-addressable memory 14 using the search key received from the search key generation circuit 12 and arbitration control for a process for accessing the content-addressable memory 14 executed by the CPU 18. The content-addressable memory 14 stores, for example, a port number and 20-byte data from the top of an Ethernet frame, that is, a search key, as an entry. Upon receiving a search key from the content-addressable memory access control circuit 13, the content-addressable memory 14 searches for an entry that matches the search key and outputs an address that stores the entry that matches the search key. This address corresponds to an address that serves as an index of an entry in the associative memory 16. The address that stores the entry that matches the search key output from the content-addressable memory 14 is transmitted to the associative memory access control circuit 15. Details of the content-addressable memory 14 will be described later with reference to FIG. 6.

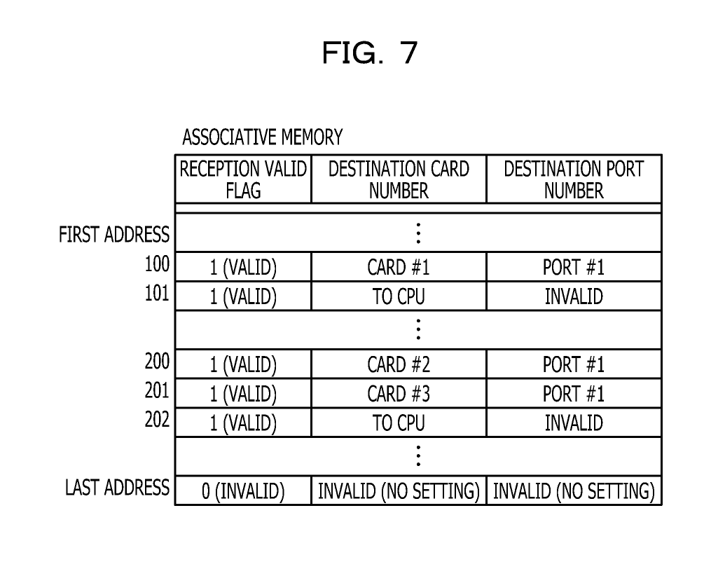

The associative memory access control circuit 15 executes a process for accessing the address of the associative memory 16 input from the content-addressable memory 14 and arbitration control for a process for accessing the associative memory 16 executed by the CPU 18. The associative memory 16 stores, as an entry, apparatus destination information (the destination card number and the destination port number) included in an apparatus header of a frame and a reception valid flag indicating permission to receive the entry. The associative memory access control circuit 15 reads an entry from the associative memory 16 using the address input from the content-addressable memory 14 as an index. The associative memory access control circuit 15 transmits the entry of the address read from the associative memory 16 to the reception judgment circuit 17. Details of the associative memory 16 will be described later with reference to FIG. 7.

The reception judgment circuit 17 judges, for example, the apparatus destination of the received frame and whether or not to discard the received frame on the basis of the entry in the associative memory 16 received from the associative memory access control circuit 15. The reception judgment circuit 17 receives the received frame from the search key generation circuit 12. The reception judgment circuit 17 then judges whether or not to discard the received frame on the basis of the reception valid flag included in the received entry in the associative memory 16. If the reception judgment circuit 17 judges that the received from is not to be discarded, the reception judgment circuit 17 stores, in the apparatus header, the destination card number and the destination port number included in the received entry in the associative memory 16 as the apparatus destination information. The reception judgment circuit 17 then adds this apparatus header to the received frame. The reception judgment circuit 17 transmits the received frame to the SW circuit 2 or the CPU 18 in accordance with the destination.

If the destination card number included in the entry in the associative memory 16 received by the reception judgment circuit 17 indicates any of the line IF circuits 1 in the communication apparatus 100, the reception judgment circuit 17 transmits the received frame to the SW circuit 2. The SW circuit 2 transfers the received frame to the destination line IF circuit 1. If the destination card number included in the entry in the associative memory 16 received by the reception judgment circuit 17 indicates a CPU, the reception judgment circuit 17 transmits the received frame to the CPU 18.

The PHY/MAC circuit 11, the search key generation circuit 12, the content-addressable memory access control circuit 13, the associative memory access control circuit 15, and the reception judgment circuit 17 are, for example, integrated circuit (IC) logic elements, field-programmable gate arrays (FPGAs), network processing units (NPUs), or the like. Alternatively, the PHY/MAC circuit 11, the search key generation circuit 12, the content-addressable memory access control circuit 13, the associative memory access control circuit 15, and the reception judgment circuit 17 may be separate elements or devices. Alternatively, at least two of the PHY/MAC circuit 11, the search key generation circuit 12, the content-addressable memory access control circuit 13, the associative memory access control circuit 15, and the reception judgment circuit 17 may be included in one or a plurality of elements or devices.

FIG. 6 is a diagram illustrating an example of entries in the content-addressable memory 14. The content-addressable memory 14 is, for example, a ternary content-addressable memory (TCAM). Each entry in the content-addressable memory 14 includes an entry valid flag, a port number, and 20-byte data from the top of a frame.

The entry valid flag is a flag indicating the validity of an entry. For example, if the entry valid flag is 1, the entry is valid. For example, if the entry valid flag is 0, the entry is invalid.

The port number indicates a reception port number. The size of the port number field is 1 byte in the example illustrated in FIG. 6. Therefore, in the example illustrated in FIG. 6, entries in the content-addressable memory 14 can be set for up to 256 ports. However, the size of the port number field is not limited to 1 byte, and may be set in accordance with the specifications of the communication apparatus 100 or the like.

The 20-byte data from the top of a frame indicates that first two VLAN tags are included in an Ethernet frame to which the two VLAN tags are provided. However, the data length from the top of a frame included in an entry in the content-addressable memory 14 is not limited to 20 bytes from the top of the frame. The data length from the top of a frame included in an entry in the content-addressable memory 14 may be set in accordance with the configuration of a network in which the communication apparatus 100 is provided or the like. However, the data length from the top of a frame included in an entry in the content-addressable memory 14 matches the data length from the top of a frame to be used for a search key.

In the example illustrated in FIG. 6, an entry of a VLAN single-tagged frame for Port 1 is registered to Address 100 of the content-addressable memory 14. The VLAN tag in this entry is TPID=0x8100 and VLAN ID=100. A first VLAN tag is located from a thirteenth byte to a sixteenth byte from the top of the Ethernet frame. Therefore, in the entry in Address 100 of the content-addressable memory 14 illustrated in FIG. 6, the value of the TPID, which is 0x8100, is stored in the thirteenth and fourteenth bytes and the value of the VLAN ID, which is 100, is stored in the fifteenth and sixteenth bytes from the top of the Ethernet frame.

In the example illustrated in FIG. 6, an entry of a bridge protocol data unit (BPDU) frame, which is one of control frames for Port 1, is registered to Address 101 of the content-addressable memory 14. In the BPDU frame, 0x0180 C200 0000 for multicast is preserved as a destination MAC address. Therefore, in the entry in Address 101 illustrated in FIG. 6, the MAC address 0x0180 C200 0000, which indicates that the frame is a BPDU frame, is stored in first six bytes, which correspond to the destination MAC address of the Ethernet frame.

In the example illustrated in FIG. 6, an entry of a VLAN single-tagged frame for Port 1 is registered to Address 200 of the content-addressable memory 14. The VLAN tag in this entry is TPID=0x8100 and VLAN ID=200. Therefore, in the entry in Address 200 of the content-addressable memory 14 illustrated in FIG. 6, the value of TPID, which is 0x8100, is stored in the thirteenth and fourteenth bytes, which correspond to the VLAN tag, from the top of the Ethernet frame. In addition, the value of the VLAN ID, which is 200, is stored in the fifteenth and sixteenth bytes, which correspond to the VLAN tag, from the top of the Ethernet frame.

In the example illustrated in FIG. 6, an entry of a VLAN double-tagged frame for Port 2 is registered to Address 201 of the content-addressable memory 14. A first (outside) VLAN tag in this entry is TPID=0x8100 and VLAN ID=300. A second (inside) VLAN tag in this entry is TPID=0x8100 and VLAN ID=400. The first VLAN tag is located from the thirteenth byte to the sixteenth byte from the top of the Ethernet frame. The second (inside) VLAN tag is located next to the first VLAN tag, that is, located from a seventeenth byte to a twenties byte from the top of the Ethernet frame. Therefore, in the entry in Address 201 illustrated in FIG. 6, the first (outside) VLAN tag (TPID=0x8100 and VLAN ID=300) is stored in the thirteenth to sixteenth bytes from the top of the Ethernet frame. In addition, the second (inside) VLAN tag (TPID=0x8100 and VLAN ID=400) is stored in the seventeenth to twenties bytes from the top of the Ethernet frame.

In the example illustrated in FIG. 6, an entry of a link aggregation control protocol (LACP) frame, which is one of the control frames for Port 1, is registered to Address 202 of the content-addressable memory 14. In the LACP frame, 0x0180 C200 0002 is preserved as a destination MAC address. Therefore, in the entry in Address 202 illustrated in FIG. 6, the MAC address 0x0180 C200 0002, which indicates that the frame is an LACP frame, is stored in the first six bytes, which correspond to the destination MAC address of the Ethernet frame.

The process for searching the content-addressable memory 14 using the search key is executed in an ascending order of address values. When an entry that perfectly matches the search key has been found, the search process is terminated, and entries having larger address values are not searched. The address value of the content-addressable memory 14 in which the entry that perfectly matches the search key is output from the content-addressable memory 14. It is to be noted that bits corresponding to “mask” in the content-addressable memory 14 are bits that may be 0 or 1.

In the example illustrated in FIG. 6, an entry in which only masks are set is set in a last address of the content-addressable memory 14. By setting the entries like this, it is possible to cause the search key to match the entry in the last address even when an entry corresponding to the search key has not been registered to the content-addressable memory 14.

FIG. 7 is a diagram illustrating an example of entries stored in the associative memory 16. The associative memory 16 is, for example, a random-access memory (RAM). Each entry in the associative memory 16 includes a reception valid flag and apparatus destination information (a destination card number and a destination port number). An address value of the associative memory 16 in which each entry is stored corresponds to an address value of the content-addressable memory 14. The entries in the associative memory 16 are, for example, set by software of the communication apparatus 100 through the CPU 18.

The reception valid flag is a flag indicating whether or not a received frame corresponding to the entry is to be received. For example, if the reception valid flag is 1, reception is valid and a received frame corresponding to the entry is allowed to be received. For example, if the reception valid flag is 0, reception is invalid and a received frame corresponding to the entry is discarded.

As the destination card number and the destination port number, a line IF circuit 1 and a port number thereof, respectively, that serve as the destinations of a received frame corresponding to the entry in the communication apparatus 100 are set.

For example, suppose that the communication apparatus 100 has received an Ethernet frame having a VLAN tag whose TPID=0x8100 and VLAN ID=100 using Port 1 of Line IF card 1. In this case, the content-addressable memory access control circuit 13 receives port number=Port 1 and 20-byte data from the top of the received frame including TPID=0x8100 and VLAN ID=100 from the search key generation circuit 12 as a search key. Since this search key matches an entry in Address 100 of the content-addressable memory 14, the content-addressable memory 14 transmits Address 100 to the associative memory access control circuit 15 when the search key has been input from the content-addressable memory access control circuit 13. The associative memory access control circuit 15 reads the entry in Address 100 from the associative memory 16 and transmits the entry to the reception judgment circuit 17. The reception valid flag of the entry in Address 100 of the associative memory 16 indicates “valid” (set to 1). Therefore, the reception judgment circuit 17 adds a destination card number and a destination port number to the received frame as an apparatus header and transmits the received frame to the SW circuit 2.

Similarly, the communication apparatus 100 transmits received frames corresponding to the entries in Addresses 200 and 201 of the associative memory 16 to a destination port of a destination card through the SW circuit 2 as user frames in accordance with destination card numbers and destination port numbers included in the entries. The received frames corresponding to the entries in Addresses 100, 200, and 201 of the content-addressable memory 14 include VLAN tags. The communication apparatus 100 identifies the received frames using the VLAN IDs and transfers the received frames to a network.

In the entries in Addresses 101 and 202 of the associative memory 16 corresponding to the BPDU frame and the LACP frame, respectively, the destination card numbers indicate the CPU 18. Therefore, the BPDU frame and the LACP frame are transmitted to the CPU 18 of the line IF circuit 1. That is, the communication apparatus 100 identifies control frames and terminates the control frames therein. Although the BPDU frame and the LACP frame are illustrated in FIGS. 6 and 7 as examples of the control frame, the control frame is not limited to these examples. A control frame may be, for example, a frame for monitoring and controlling the state of a physical link or a remote apparatus or may be a frame for monitoring and controlling the topological state or the routing state in the network.

As illustrated in FIGS. 6 and 7, the content-addressable memory 14 and the associative memory 16 store, for example, individual entries in accordance with various pieces of information such as ports, VLANs, user frames, and control frames. Therefore, when the setting of filtering is to be changed, the software of the communication apparatus 100 invalidates each entry in the content-addressable memory 14 and the associative memory 16 that is not to be used after the change in the setting of the filtering. The software of the communication apparatus 100 validates or adds each entry in or to the content-addressable memory 14 and the associative memory 16 that is to be used after the change in the setting of the filtering. When there are a large number of entries to be invalidated or validated, the number of processes for invalidating and validating the entries is large, thereby increasing the processing load. In addition, it takes time to complete the processes for invalidating and validating the entries, which results in an increase in the switching time of packet filtering. In order to suppress an increase in the switching time of packet filtering, it is desirable to perform access control on a large number of entries in the content-addressable memory 14 in as short a period as possible. Therefore, the load on the CPU 18 or the software undesirably increases.

In a first embodiment, line IF circuits are configured as described below in order to decrease the switching time of the packet filtering and suppress an increase in the load on the CPU 18 or the software. Description of components that are the same as those described above is omitted.

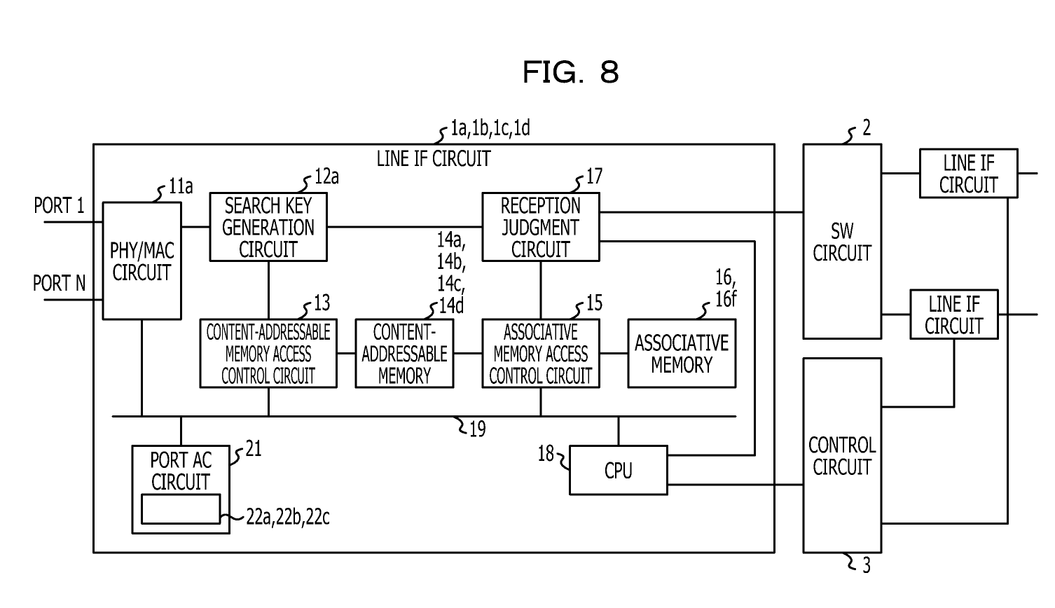

FIG. 8 is a diagram illustrating an example of a line IF circuit 1a according to the first embodiment. The line IF circuit 1a includes a PHY/MAC circuit 11a, a search key generation circuit 12a, a content-addressable memory access control circuit 13, a content-addressable memory 14a, an associative memory access control circuit 15, an associative memory 16, a reception judgment circuit 17, a CPU 18, and a port AC circuit 21. In the example illustrated in FIG. 8, only the configuration of the reception side of the line IF circuit 1a illustrated. The configuration of the line IF circuit 1a according to the first embodiment is the same as that of the line IF circuit 1 illustrated in FIG. 5, except for the PHY/MAC circuit 11a, the search key generation circuit 12a, the content-addressable memory 14a, and the port AC circuit 21.

The port AC circuit 21 has a memory. The memory stores a port AC table 22a. In the port AC table 22a, an action code value for determining a processing operation to be performed by each port of the line IF circuit 1a on a frame is set. When a port has received a frame, the port AC circuit 21 reads an entry in the port from the port AC table 22a and obtains the action code value. The port AC circuit 21 then transmits the obtained action code value to the PHY/MAC circuit 11a. The port AC circuit 21 is an example of an action code circuit according to the aspect.

When a port has received a frame, the PHY/MAC circuit 11a accesses the port AC circuit 21 and obtains the action code value set for the reception port. The PHY/MAC circuit 11a transmits the action code value and the received frame to the search key generation circuit 12a. The search key generation circuit 12a generates a search key by combining the reception port number and the action code value of the received frame and the 20-byte data from the top of the received frame. The process for searching by the content-addressable memory 14a is executed using this search key. The search key generation circuit 12a is an example of a generation circuit according to the aspect. The reception judgment circuit 17 is an example of a judgment circuit according to the aspect.

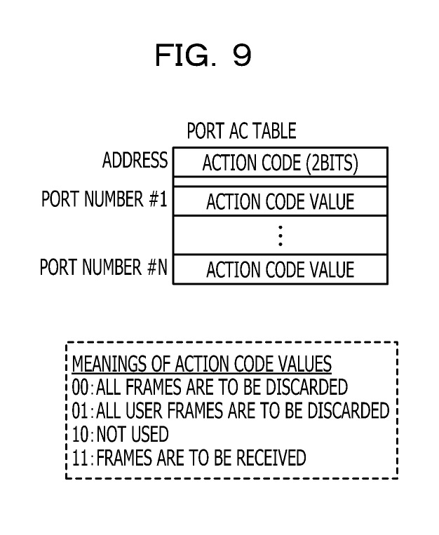

FIG. 9 is a diagram illustrating an example of entries in the port AC table 22a according to the first embodiment. The addresses of the port AC table 22a correspond to the port numbers. An action code is a 2-bit code. An action code value “00” indicates that all frames are to be discarded. An action code value “01” indicates that all user frames are to be discarded. An action code value “11” indicates that frames are not to be discarded (to be received). The port AC table 22a is an example of a first memory according to the aspect. The action code value is an example of an identifier according to the aspect.

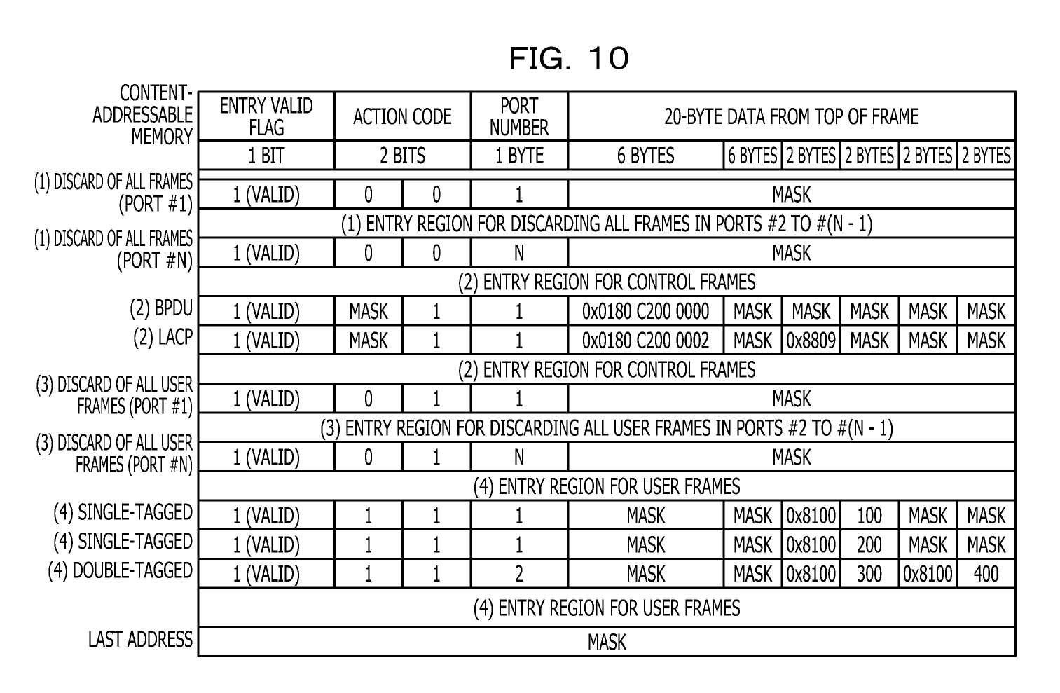

FIG. 10 is a diagram illustrating an example of entries in the content-addressable memory 14a according to the first embodiment. In each entry in the content-addressable memory 14a according to the first embodiment, an action code is included in addition to an entry valid flag, a port number, and 20-byte data from the top of a frame. The content-addressable memory 14a is an example of a content-addressable memory according to the aspect.

A process for searching the entries in the content-addressable memory 14a is executed in an ascending order of address values. When an entry that perfectly matches the search key has been found, entries having larger address values are not searched. Therefore, the entries in the content-addressable memory 14a are arranged in the following order: “(1) entries for discarding all frames”; “(2) entries for control frames”; “(3) entries for discarding all user frames”; and “(4) entries for user frames”. In addition, entries having stricter conditions come earlier. The “(1) entries for discarding all frames” are entries having the action code value “00”. The “(3) entries for discarding all user frames” are entries having the action code value “01”. The action code value of the “(2) entries for control frames” is set to “mask, 1”. The action code value of the “(4) entries for user frames” is set to “11”.

The number of the “(1) entries for discarding all frames” and the number of the “(3) entries for discarding all user frames” prepared are the same as the number of ports provided for the line IF circuit 1a. In the 20-byte data from the top of a frame of each of the “(1) entries for discarding all frames” and the “(3) entries for discarding all user frames”, only masks are set. The reason why only masks are set in the 20-byte data from the top of the frame of each of the “(3) entries for discarding all user frames” is that the entries in the content-addressable memory 14a include the action codes. In addition, since the address values of the “(2) entries for control frames” are smaller than those of the “(3) entries for discarding all user frames”, the process for searching the control frames using the search key ends before the “(3) entries for discarding all user frames”. Therefore, although masks are set in the 20-byte data from the top of the frame of each of the “(3) entries for discarding all user frames”, since the control frames are processed in the entries having smaller address values, only the user frames are discarded. In the case of the content-addressable memory 14a, too, an entry in which only masks are set is registered to a last address.

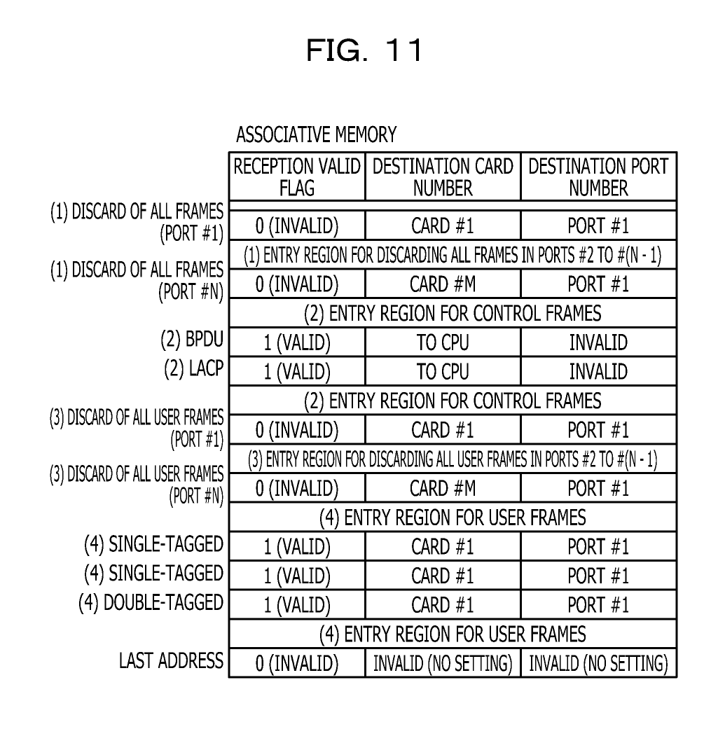

FIG. 11 is a diagram illustrating an example of entries in the associative memory 16 according to the first embodiment. In the associative memory 16, the reception valid flags of entries corresponding to the “(1) entries for discarding all frames” and the “(3) entries for discarding all user frames” in the content-addressable memory 14a are set to 0 (invalid) by the software of the communication apparatus 100. The associative memory 16 is an example of a second memory according to the aspect. The reception valid flag is an example of processing information according to the aspect.

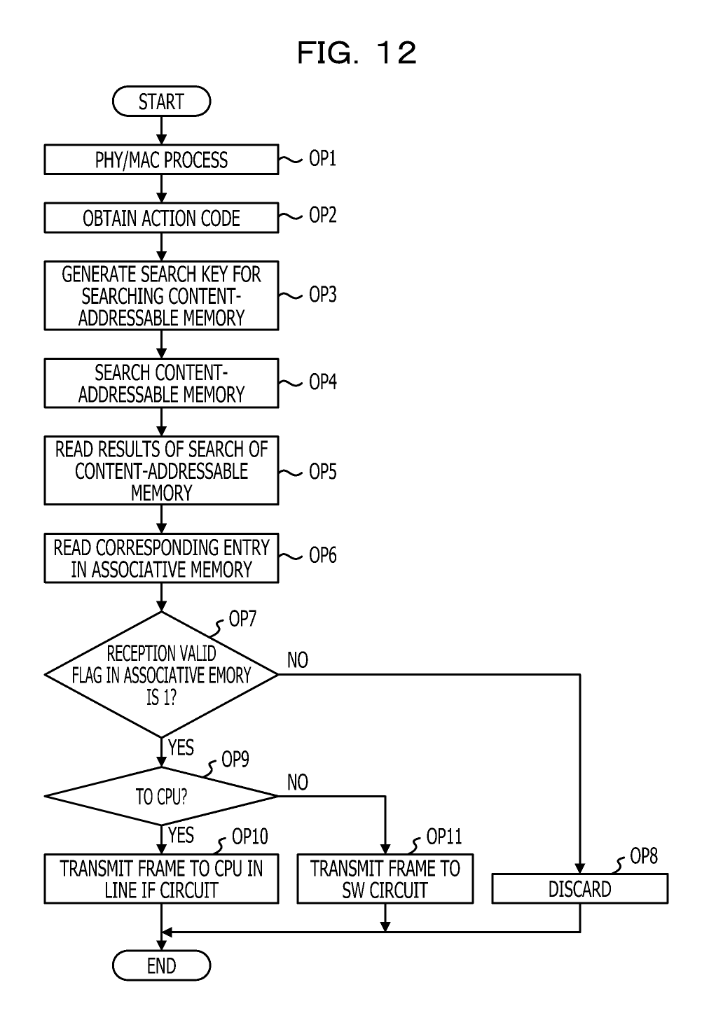

FIG. 12 is a flowchart illustrating an example of a process for receiving a frame executed by the line IF circuit 1a. The flowchart of FIG. 12 begins when a frame has been received by a port in the line IF circuit 1a.

In OP1, the received frame is subjected to the termination process in the physical layer and the MAC layer executed by the PHY/MAC circuit 11a. For example, in the MAC layer, an FCS check is performed. If an error has been found in the received frame by the FCS check, the received frame is discarded. If no error has been found in the received frame by the FCS check, the process proceeds to OP2.

In OP2, the port AC circuit 21 obtains an action code value of the received frame set for the reception port from the port AC table 22a. The action code value is transmitted to the PHY/MAC circuit 11a. The process then proceeds to OP3.

In OP3, the search key generation circuit 12a generates a search key of the received frame searching for the content-addressable memory 14a. The search key generation circuit 12a receives the received frame and the action code value set for the reception port from the PHY/MAC circuit 11a. The search key generation circuit 12a generates the search key by combining the reception port number and the action code value of the received frame and the 20-byte data from the top of the received frame. The search key is transmitted to the content-addressable memory access control circuit 13. The process then proceeds to OP4.

In OP4, the content-addressable memory access control circuit 13 searches the content-addressable memory 14a using the search key of the received frame. The process then proceeds to OP5.

In OP5, an address obtained by searching the content-addressable memory 14a using the search key of the received frame, the address storing an entry that matches the search key, is output from the content-addressable memory 14a to the associative memory access control circuit 15. The process then proceeds to OP6.

In OP6, the associative memory access control circuit 15 reads, from the associative memory 16, an entry corresponding to the address obtained by searching the content-addressable memory 14a. The associative memory access control circuit 15 transmits the read entry in the associative memory 16 to the reception judgment circuit 17. The process then proceeds to OP7.

In OP7, the reception judgment circuit 17 judges whether or not the reception valid flag of the entry in the associative memory 16 detected for the received frame is 1, that is, whether or not the received frame is allowed to be received. If the reception valid flag is 1 (YES in OP7), the process proceeds to OP9. If the reception valid flag is 0 (NO in OP7), the process proceeds to OP8.

In OP8, since the reception valid flag of the entry in the associative memory 16 detected for the received frame is 0, reception of the received frame is rejected. Therefore, the received frame is discarded. Thereafter, the flowchart of FIG. 12 ends.

In OP9, the reception judgment circuit 17 judges whether or not the apparatus destination of the received frame is the CPU 18. The reception judgment circuit 17 identifies the apparatus destination of the received frame using the destination card number of the entry in the associative memory 16 detected for the received frame. If the apparatus destination of the received frame is the CPU 18 (YES in OP9), the process proceeds to OP10. If the apparatus destination of the received frame is not the CPU 18, that is, if the apparatus destination of the received frame is another line IF circuit (NO in OP9), the process proceeds to OP11.

In OP10, the reception judgment circuit 17 transmits the received frame to the CPU 18. Thereafter, the flowchart of FIG. 12 ends.

In OP11, the reception judgment circuit 17 transmits the received frame to the SW circuit 2. At this time, the reception judgment circuit 17 transmits the received frame to the SW circuit 2 after adding, to the received frame, an apparatus header including the destination card number and the destination port number of the entry in the associative memory 16 detected for the received frame. Thereafter, the flowchart of FIG. 12 ends. It is to be noted that the SW circuit 2 transfers the received frame to which the apparatus header has been added to a line IF circuit indicated by the destination card number of the entry in the associative memory 16 detected for the received frame.

Examples of an operation for setting Port 1 of the line IF circuit 1a will be described. In the following operation examples, the content-addressable memory 14a is in the state illustrated in FIG. 10, and the associative memory 16 is in the state illustrated in FIG. 11.

### Operation Example 1

### When all Received Frames are to be Discarded

In an operation example 1, the software of the communication apparatus 100 sets the action code value of an entry in the port AC table 22a corresponding to Port 1 to “00”. Therefore, a search key of the received frame in Port 1 includes the action code “00”. As a result, by searching the content-addressable memory 14a, the search key of the received frame finds the “(1) entries for discarding all frames” in the content-addressable memory 14a illustrated in FIG. 10. Since the reception valid flags are 0 in the “(1) entries for discarding all frames” in the associative memory 16 illustrated in FIG. 11 corresponding to the “(1) entries for discarding all frames” in the content-addressable memory 14a illustrated in FIG. 10 (NO in OP7 illustrated in FIG. 12), the received frame in Port 1 is discarded by the reception judgment circuit 17 (OP8 illustrated in FIG. 12).

### Operation Example 2

### When Control Frames are to be Received but User Frames are to be Discarded

In an operation example 2, the software of the communication apparatus 100 sets the action code value of an entry in the port AC table 22a corresponding to Port 1 to “01”. Therefore, a search key of the received frame in Port 1 includes the action code “01”.

When the received frame is a control frame, a search key of the received frame finds the “(2) entries for control frames” in the content-addressable memory 14a illustrated in FIG. 10 by searching the content-addressable memory 14a. Since the reception valid flags are 1 in the “(2) entries for control frames” in the associative memory 16 illustrated in FIG. 11 corresponding to the “(2) entries for control frames” in the content-addressable memory 14a illustrated in FIG. 10 (YES in OP7 illustrated in FIG. 12), the received frame in Port 1 is allowed to be received. In addition, since the destination card numbers are “CPU” in the “(2) entries for control frames” in the associative memory 16 illustrated in FIG. 11 (YES in OP9 illustrated in FIG. 12), the received frame in Port 1 is transmitted to the CPU 18 by the reception judgment circuit 17 (OP10 illustrated in FIG. 12).

When the received frame is a user frame, a search key of the received frame finds the “(3) entries for discarding all user frames” in the content-addressable memory 14a illustrated in FIG. 10 by searching the content-addressable memory 14a. Since the reception valid flags are 0 in the “(3) entries for discarding all user frames” in the associative memory 16 illustrated in FIG. 11 corresponding to the “(3) entries for discarding all user frames” in the content-addressable memory 14a illustrated in FIG. 10 (NO in OP7 illustrated in FIG. 12), the received frame is discarded by the reception judgment circuit 17 (OP8 illustrated in FIG. 12).

### Operation Example 3

### When all Frames are to be Received

In an operation example 3, the software of the communication apparatus 100 sets the action code value of an entry in the port AC table 22a corresponding to Port 1 to “11”. Therefore, a search key of the received frame in Port 1 includes the action code “11”.

When the received frame is a control frame, a search key of the received frame finds the “(2) entries for control frames” in the content-addressable memory 14a illustrated in FIG. 10 by searching the content-addressable memory 14a. Since the reception valid flags are 1 in the “(2) entries for control frames” in the associative memory 16 illustrated in FIG. 11 corresponding to the “(2) entries for control frames” in the content-addressable memory 14a illustrated in FIG. 10 (YES in OP7 illustrated in FIG. 12), the received frame in Port 1 is allowed to be received. In addition, since the destination card numbers are “CPU” in the “(2) entries for control frames” in the associative memory 16 illustrated in FIG. 11 (YES in OP9 illustrated in FIG. 12), the received frame in Port 1 is transmitted to the CPU 18 by the reception judgment circuit 17 (OP10 illustrated in FIG. 12).

When the received frame is a user frame, a search key of the received frame finds the “(4) entries for user frames” in the content-addressable memory 14a illustrated in FIG. 10 by searching the content-addressable memory 14a. Since the reception valid flags are 1 in the “(4) entries for user frames” in the associative memory 16 illustrated in FIG. 11 corresponding to the “(4) entries for user frames” in the content-addressable memory 14a illustrated in FIG. 10 (YES in OP7 illustrated in FIG. 12), the received frame is allowed to be received. In addition, since the destination card numbers store the number of another line IF circuit (NO in OP9 illustrated in FIG. 12) in the “(4) entries for user frames” in the associative memory 16 illustrated in FIG. 11, the received frame in Port 1 is transmitted to the SW circuit 2 by the reception judgment circuit 17 (OP11 illustrated in FIG. 12).

In the first embodiment, action codes are included in the entries in the content-addressable memory 14a, and entries corresponding to the action code values are registered to the content-addressable memory 14a and the associative memory 16 in advance. In addition, the reception valid flags of the entries in the associative memory 16 are set in such a way as to cooperate with processing operations indicated by the action codes included in the entries in the content-addressable memory 14a. As a result, just by changing the action code values for each port, entries in the content-addressable memory 14a found by a search key of a received frame change, thereby changing the setting of the filtering of the received frame. At this time, the setting of the entries in the content-addressable memory 14a and the associative memory 16 is not changed.

Therefore, according to the first embodiment, the setting of the packet filtering can be changed by changing the action code values included in the entries in the port AC table 22a, and accordingly the time taken to switch the packet filtering can be reduced. In addition, since the entries in the content-addressable memory 14a and the associative memory 16 are not changed, the processing load generated by switching the packet filtering can be suppressed. In addition, since the entries in the content-addressable memory 14a are not changed, access control for a large number of entries in the content-addressable memory 14a is not performed in accordance with the switching of the packet filtering. Therefore, it is possible to suppress the load on the CPU 18 or the software. That is, according to the first embodiment, it is possible to collectively change the setting of the packet filtering at high speed.

A line IF circuit 1b (FIG. 8) according to a second embodiment has the same configuration as the line IF circuit 1a according to the first embodiment, except for a content-addressable memory 14b and a port AC table 22b. In the second embodiment, a port group including a plurality of ports of the line IF circuit 1b is introduced. In the content-addressable memory 14b and the associative memory 16, the plurality of ports included in the port group are controlled by a single entry. In the second embodiment, description of components that are the same as those according to the first embodiment is omitted.

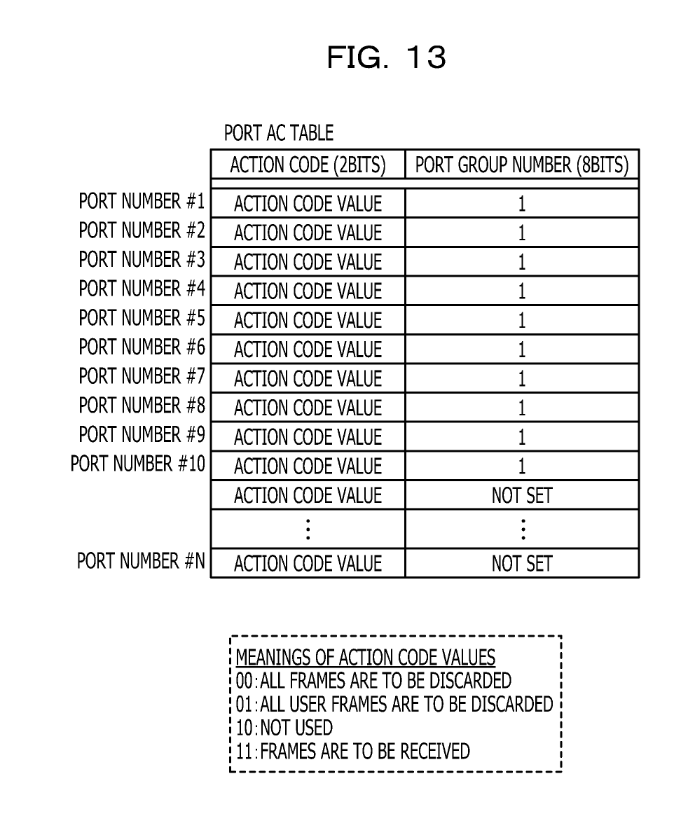

FIG. 13 is a diagram illustrating an example of entries in the port AC table 22b according to the second embodiment. In the entries in the port AC table 22b, port group numbers are included in addition to the action code values. In entries in physical ports that belong to the same port group, the same value is set for the port group numbers. In entries in a port that does not belong to any port group, values are not set for the port group numbers (alternatively, “null” is set). In the example illustrated in FIG. 13, Ports 1 to 10 are included in a port group having a port group number of 1.

The port AC circuit 21 reads the port group values set in the port AC table 22b as well as the action code values and transmits the port group values and the action code values to the search key generation circuit 12a through the PHY/MAC circuit 11a. The search key generation circuit 12a generates a search key by combining the reception port number, the action code value, and the port group value of a received frame and the 20-byte data from the top of the received frame.

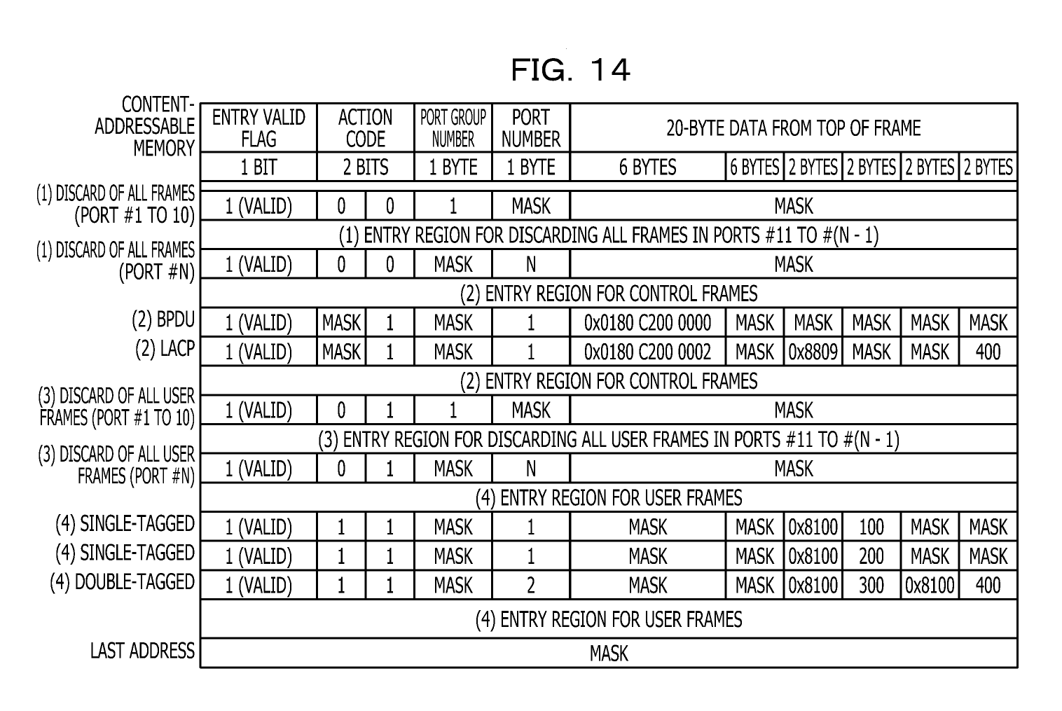

FIG. 14 is a diagram illustrating an example of entries in the content-addressable memory 14b according to the second embodiment. In the entries in the content-addressable memory 14b, the port group numbers are included in addition to the entry valid flags, the action codes, the port numbers, and the 20-byte data from the tops of frames. In the port group numbers of the entries in the content-addressable memory 14b, the same values as the port group numbers of the entries in the port AC table 22b corresponding to the port numbers stored in reception ports are set. When a reception port does not belong to any port group, a mask is set for the port group number of an entry in the content-addressable memory 14b. The example of the content-addressable memory 14b illustrated in FIG. 14 corresponds to the port AC table 22b illustrated in FIG. 13, and Ports 1 to 10 are included in the port group having a port group number of 1. Therefore, the “(1) entries for discarding all frames” and the “(3) entries for discarding all user frames” in the content-addressable memory 14b illustrated in FIG. 14 corresponding to Ports 1 to 10 each become one entry.

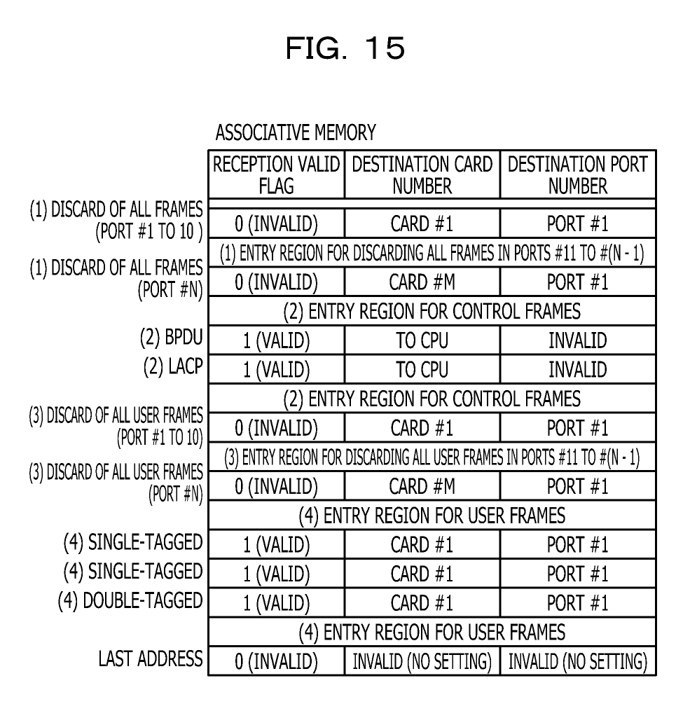

FIG. 15 is a diagram illustrating an example of entries in the associative memory 16 according to the second embodiment. The example of the associative memory 16 illustrated in FIG. 15 corresponds to the content-addressable memory 14b illustrated in FIG. 14. In the associative memory 16, as with the content-addressable memory 14b, the “(1) entries for discarding all frames” and the “(3) entries for discarding all user frames” corresponding to Ports 1 to 10 each become one entry.

In the second embodiment, by using the port group numbers, entries for a plurality of physical ports in the content-addressable memory 14b and the associative memory 16 can be managed by one entry (for example, FIGS. 14 and 15). Therefore, according to the second embodiment, the number of entries in the content-addressable memory 14b and the associative memory 16 can be reduced, thereby reducing the amount of data in the content-addressable memory 14b and the associative memory 16. In the second embodiment, the packet filtering of a plurality of physical ports that belong to the same port group can be collectively set, and the setting of the packet filtering can be collectively changed. Therefore, for example, the second embodiment is appropriate when a plurality of physical ports such as link aggregation are treated as a single logical port.

In a third embodiment, a line IF circuit is configured such that the communication apparatus 100 can execute loopback of a received frame. “Loopback” is to transmit the same frame from a port that has received a frame. In the third embodiment, loopback is performed by sending a frame through the SW circuit 2 back to a port that has received the frame. Loopback is, for example, used to make a fault diagnosis or the like for an apparatus in units of ports before a network is operated or when an investigation operation or the like is to be performed after occurrence of a fault. The configuration of a line IF circuit 1c (FIG. 8) according to the third embodiment is the same as that of the line IF circuit 1a according to the first embodiment, except for a content-addressable memory 14c and a port AC table 22c. Description of components according to the third embodiment that are the same as those according to the first embodiment is omitted.

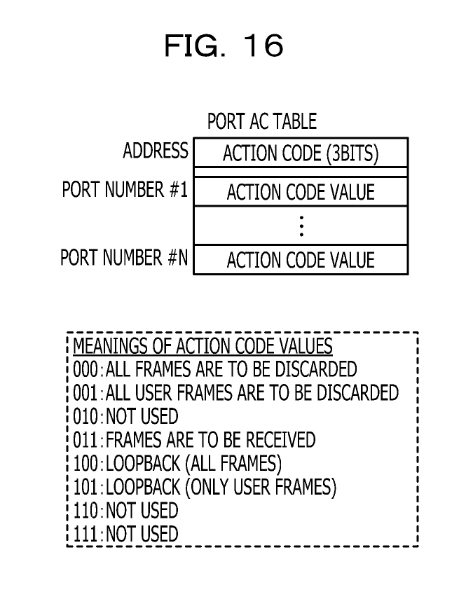

FIG. 16 is a diagram illustrating an example of entries in the port AC table 22c according to the third embodiment. In the third embodiment, each action code has 3 bits. An action code value “000” indicates that all frames received by a port are to be discarded. An action code value “001” indicates that all user frames received by a port are to be discarded. An action code value “011” indicates that all frames received by a port are not to be discarded (to be received). An action code value “100” indicates that all frames received by a port are to be looped back. An action code value “101” indicates that all user frames received by a port are to be looped back.

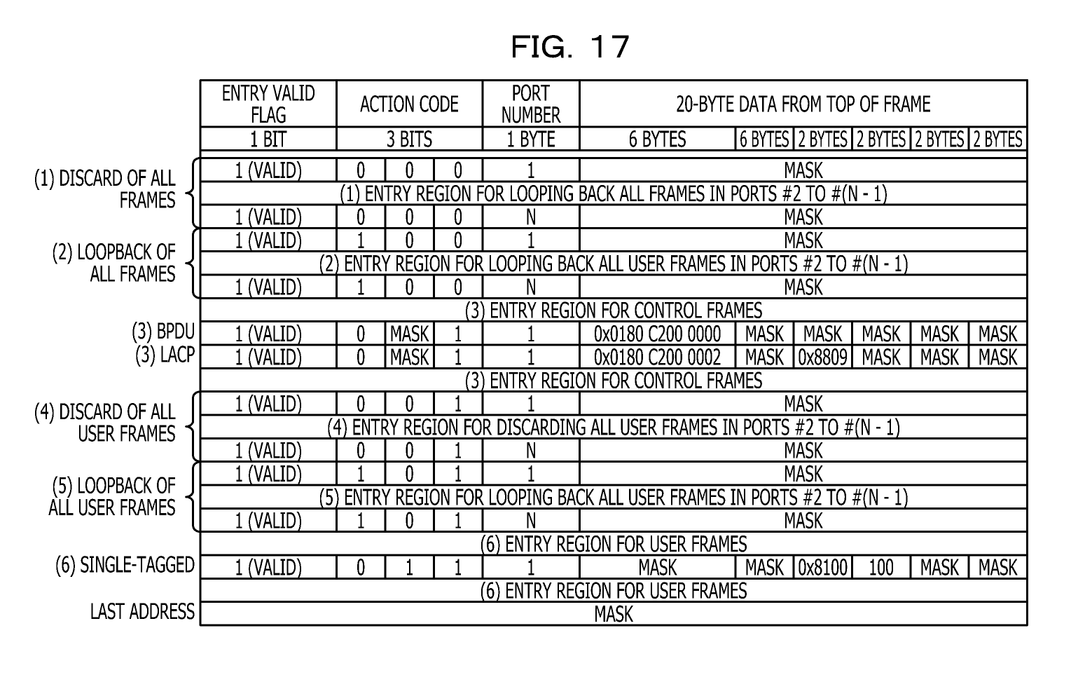

FIG. 17 is a diagram illustrating an example of entries in the content-addressable memory 14c according to the third embodiment. In the entries in the content-addressable memory 14c according to the third embodiment, each action code has 3 bits. In the content-addressable memory 14c according to the third embodiment, entries for loopback are added.

Because a process for searching the entries in the content-addressable memory 14c is executed in an ascending order of address values, “(1) entries for discarding all frames”, “(2) entries for looping back all frames”, “(3) entries for control frames”, “(4) entries for discarding all user frames”, “(5) entries for looping back all user frames”, and “(6) an entry for user frames” are arranged in this order. The “(1) entries for discarding all frames” are entries having the action code value “000”. The “(2) entries for looping back all frames” are entries having the action code value “100”. The “(4) entries for discarding all user frames” are entries having the action code value “001”. The “(5) entries for looping back all user frames” are entries having the action code value “101”. The action code values of the “(3) entries for control frames” are set to “0, mask, 1”. The action code values of the “(4) entries for user frames” are set to “011”.

The number of the “(1) entries for discarding all frames”, the number of the “(2) entries for looping back all frames”, the number of “(4) entries for discarding all user frames”, and the number of the “(5) entries for looping back all user frames” prepared are the same as the number of ports provided for the line IF circuit 1c. Only masks are set in the 20-byte data from the top of a frame of each of the “(1) entries for discarding all frames”, the “(2) entries for looping back all frames”, the “(4) entries for discarding all user frames”, and the “(5) entries for looping back all user frames”. In the content-addressable memory 14c, too, an entry in which only masks are set is registered to a last address.

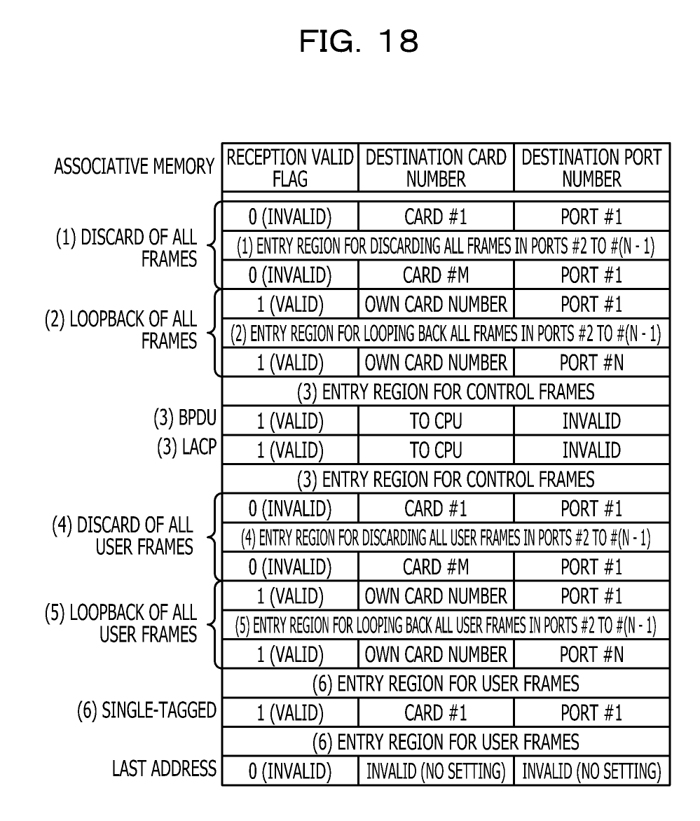

FIG. 18 is a diagram illustrating an example of entries in the associative memory 16 according to the third embodiment. The associative memory 16 illustrated in FIG. 18 corresponds to the content-addressable memory 14c illustrated in FIG. 17. In the associative memory 16 according to the third embodiment, as with the content-addressable memory 14c, entries for loopback are added. In the associative memory 16, too, the number of the “(1) entries for discarding all frames”, the number of the “(2) entries for looping back all frames”, the number of “(4) entries for discarding all user frames”, and the number of the “(5) entries for looping back all user frames” prepared are the same as the number of ports provided for the line IF circuit 1c. In each of the “(2) entries for looping back all frames” and the “(4) entries for looping back all user frames” in the associative memory 16, the reception valid flag is 1 (valid), the destination card number is the card number of the line IF circuit 1c itself, and the destination port number is each port number of the line IF circuit 1c.

### Operation Example 4

### When all Frames are to be Looped Back

In an operation example 4, the software of the communication apparatus 100 sets the action code value of an entry in the port AC table 22c corresponding to Port 1 to “100”. As a result, the action code=100 is included in a search key of a received frame in Port 1.

Since the action code value included in the search key is “100”, the search key of the received frame finds the “(2) entries for looping back all frames” by searching the content-addressable memory 14c. Since the reception valid flag is 1 in each of the “(2) entries for looping back all frames” in the associative memory 16 illustrated in FIG. 18 corresponding to each of the “(2) entries for looping back all frames” in the content-addressable memory 14c illustrated in FIG. 17, the received frame in Port 1 is allowed to be received. In addition, in each of the “(2) entries for looping back all frames” in the associative memory 16 illustrated in FIG. 18, the card number of the line IF circuit 1c itself is stored in the destination card number and Port 1, which is the reception port, is stored in the destination port number. Therefore, an apparatus header in which the destination card number is the card number of the line IF circuit 1c itself and the destination port number is Port 1, which is the reception port, is added to the received frame, and the received frame is transmitted to the SW circuit 2 by the reception judgment circuit 17. The received frame is then transmitted to the line IF circuit 1c by the SW circuit 2 again. The apparatus header is removed by the line IF circuit 1c, and the received frame is transmitted from Port 1 again.

### Operation Example 5

### When all User Frames are to be Looped Back

In an operation example 5, the software of the communication apparatus 100 sets the action code value of an entry in the port AC table 22c corresponding to Port 1 to “101”. As a result, the action code 101 is included in a search key of a received frame in Port 1.

When the received frame is a control frame, the search key of the received frame finds the “(3) entries for control frames” in the content-addressable memory 14c illustrated in FIG. 17 by searching the content-addressable memory 14c. Since the reception valid flag is 1 in each of the “(3) entries for controls frames” in the associative memory 16 illustrated in FIG. 18 corresponding to each of the “(3) entries for control frames” in the content-addressable memory 14c illustrated in FIG. 17, the received frame in Port 1 is allowed to be received. In addition, since the destination card number is “CPU” in each of the “(3) entries for control frames” in the associative memory 16 illustrated in FIG. 18, the received frame in Port 1 is transmitted to the CPU 18 by the reception judgment circuit 17.

When the received frame is a user frame, since the action code value included in the search key is “101”, the search key of the received frame finds the “(5) entries for looping back all user frames” in the content-addressable memory 14c illustrated in FIG. 17. Since the reception valid flag is 1 in each of the “(5) entries for looping back all user frames” in the associative memory 16 illustrated in FIG. 18 corresponding to each of the “(5) entries for looping back all user frames” in the content-addressable memory 14c illustrated in FIG. 17, the received frame in Port 1 is allowed to be received. In addition, in each of the “(5) entries for looping back all user frames” in the associative memory 16 illustrated in FIG. 18, the card number of the line IF circuit 1c itself is stored in the destination card number and Port 1, which is the reception port, is stored in the destination port number. Therefore, an apparatus header in which the destination card number is the card number of the line IF circuit is itself and the destination port number is Port 1, which is the reception port, is added to the received frame, and the received frame is transmitted to the SW circuit 2 by the reception judgment circuit 17. The received frame is then transmitted to the line IF circuit 1c by the SW circuit 2 again. The apparatus header is removed by the line IF circuit 1c, and the received frame is transmitted from Port 1 again.

As described above, according to the third embodiment, each action code has 3 bits and the action code value for specifying loopback is introduced. As a result, the communication apparatus 100 can execute loopback for each port without adding, deleting, rearranging, or changing the entries in the content-addressable memory 14c. It is also possible to set the port group numbers according to the second embodiment in the entries in the port AC table 22c and the content-addressable memory 14c.

The configuration of a line IF circuit 1d (FIG. 8) according to a fourth embodiment may be any of the configurations of the line IF circuit 1a according to the first embodiment to the line IF circuit 1c according to the third embodiment, except for an associative memory 16d.

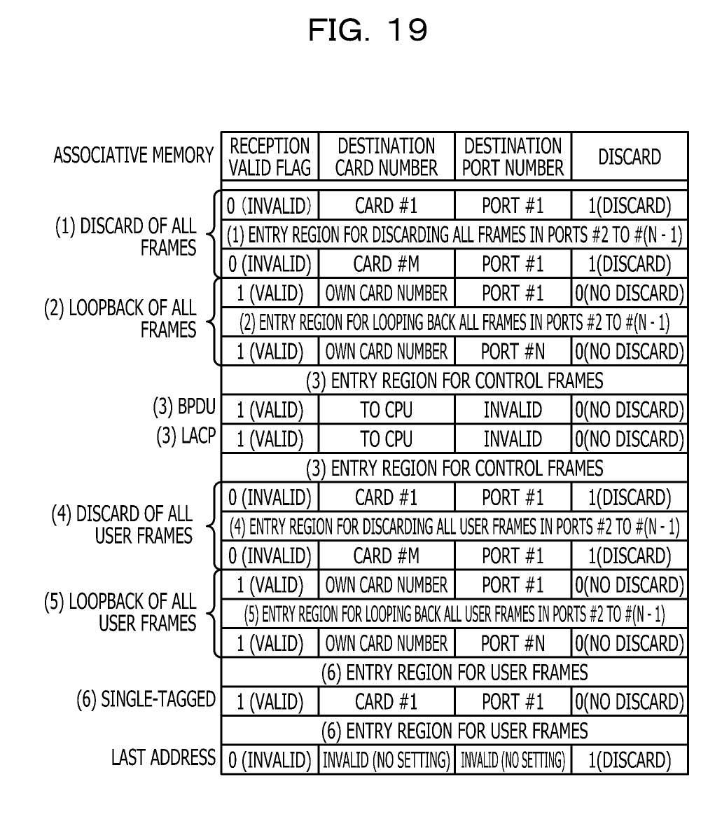

FIG. 19 is a diagram illustrating an example of entries in the associative memory 16d according to the fourth embodiment. In each of the entries in the associative memory 16d according to the fourth embodiment, a discard flag is included in addition to the reception valid flag, the destination card number, and the destination port number. For example, when the discard flag is 0, discard is not to be performed, and when the discard flag is 1, discard is to be performed. When the discard flag of an entry in the associative memory 16d is 1, a received frame corresponding to the entry is discarded. The entries in the associative memory 16d illustrated in FIG. 19 correspond to the entries in the content-addressable memory 14c according to the third embodiment. However, the entries in the associative memory 16d according to the fourth embodiment may correspond to either the entries in the content-addressable memory 14a according to the first embodiment or the entries in the content-addressable memory 14b according to the second embodiment instead.

The reception valid flag of each of the entries in the associative memory 16d indicates, for example, that a frame is to be received when the reception valid flag is valid (set to 1) and that a frame is to be discarded when the reception valid flag is invalid (set to 0). However, the reception valid flag indicates the validity of an entry. For example, when the entry valid flag in an entry in the content-addressable memory 14c is valid (set to 1) but the reception valid flag in a corresponding entry in the associative memory 16d indicates discard (set to 0) due to a setting failure of the software during registration or deletion of an entry, a received frame is discarded. In this case, it is not clear whether the discard of the received frame is intended or due to disagreement in the setting between the content-addressable memory 14c and the associative memory 16d.

By providing the discard flags for the associative memory 16d, it is possible to clearly judge whether discard of a frame is intended or due to a setting failure. For example, when a received frame has been discarded because the reception valid flag is invalid (set to 0), the reception judgment circuit 17 notifies the CPU 18 of the discard, and the CPU 18 checks the discard flag of the entry. In doing so, disagreement in the setting between the content-addressable memory 14c and the associative memory 16d can be detected.

In a fifth embodiment, the communication apparatus 100 counts the number of received frames that have found entries in a content-addressable memory and collects statistical information.

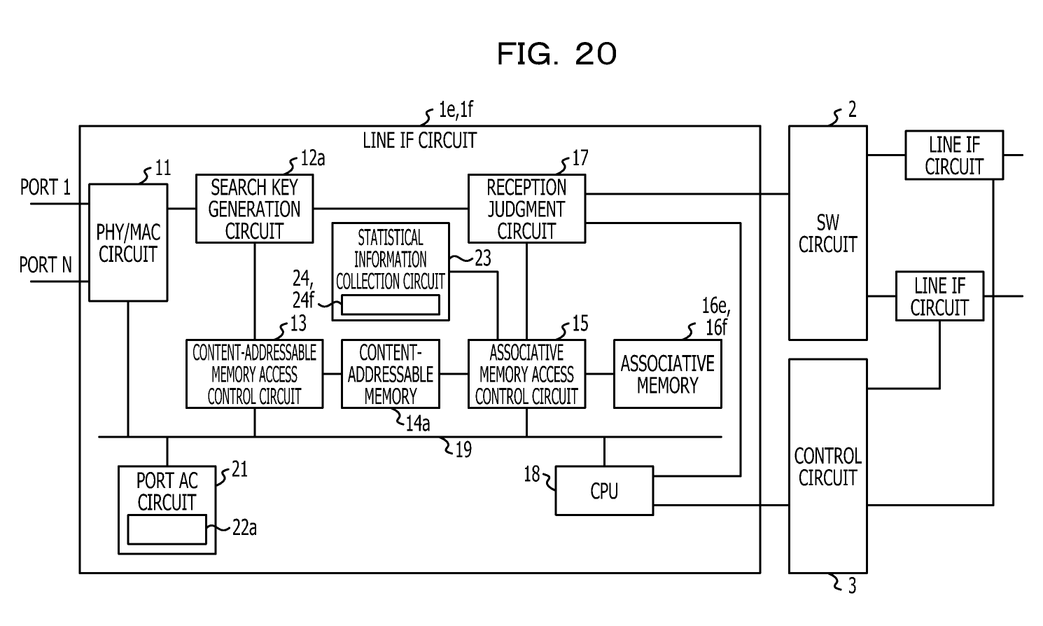

FIG. 20 is a diagram illustrating an example of a line IF circuit 1e according to the fifth embodiment. The line IF circuit 1e newly includes a statistical information collection circuit 23. In the example illustrated in FIG. 20, only the configuration of the reception side of the line IF circuit 1e is illustrated. The configuration of the line IF circuit 1e according to the fifth embodiment may be the same as that of the line IF circuit according to any of the first to fourth embodiments, except for the statistical information collection circuit 23. In the following description, the configuration of the line IF circuit 1e except for the statistical information collection circuit 23 is assumed to be the same as that of the line IF circuit 1a according to the first embodiment.

In the fifth embodiment, the associative memory access control circuit 15 transmits, to the statistical information collection circuit 23, the addresses of entries in the content-addressable memory 14a that have been found by a frame received from the content-addressable memory 14a.

The statistical information collection circuit 23 stores a statistical information table 24 in a memory in the statistical information collection circuit 23. Upon receiving an address of the content-addressable memory 14a from the associative memory access control circuit 15, the statistical information collection circuit 23 increases the count value of the received address of the content-addressable memory 14a by one.

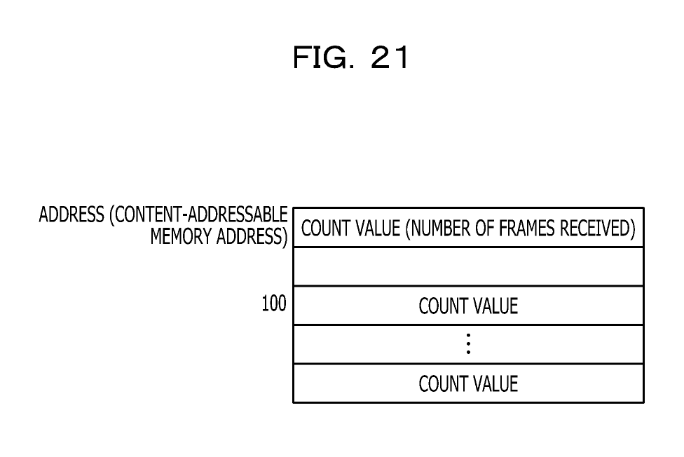

FIG. 21 is a diagram illustrating an example of the statistical information table 24. The statistical information table 24 holds the count values of the addresses of the content-addressable memory 14a as table indices. Each count value indicates the number of received frames that have found the corresponding entry in the content-addressable memory 14a. In FIG. 21, each count value indicates the number of frames received. However, the number of bytes received may be held as the count value instead.

For example, when a received frame has found an entry in Address 100 of the content-addressable memory 14a, the associative memory access control circuit 15 transmits Address 100 to the statistical information collection circuit 23. The statistical information collection circuit 23 increases the count value of Address 100 in the statistical information table 24 by one.

By reading the statistical information table 24 using the software, the number of frames that have found each entry in the content-addressable memory 14a can be detected. Since the addresses of the content-addressable memory 14a correspond to the addresses of the associative memory 16, it is possible to judge whether the number of frames that have found each entry in the statistical information table 24 is the number of frames received or the number of frames discarded. For example, by accumulating the numbers of frames that have found the entries in the statistical information table 24 corresponding to the addresses of entries in the associative memory 16 in which the reception valid flags indicate valid, the total number of frames received by the line IF circuit 1e can be provided for a user. In addition, for example, by accumulating the numbers of frames that have found the entries in the statistical information table 24 corresponding to the addresses of entries in the associative memory 16 in which the reception valid flags indicate invalid (discard), the total number of frames discarded by the line IF circuit 1e can be provided for the user. In the fifth embodiment, the statistical information can be collected for each entry in the content-addressable memory 14a, and therefore detailed statistical information regarding each frame processed in the communication apparatus 100 can be provided.

In a sixth embodiment, the communication apparatus 100 collects aggregate statistical information. The configuration of a line IF circuit 1f (FIG. 20) according to the sixth embodiment is the same as that of the line IF circuit 1e according to the fifth embodiment, except for an associative memory 16f and a statistical information table 24f.

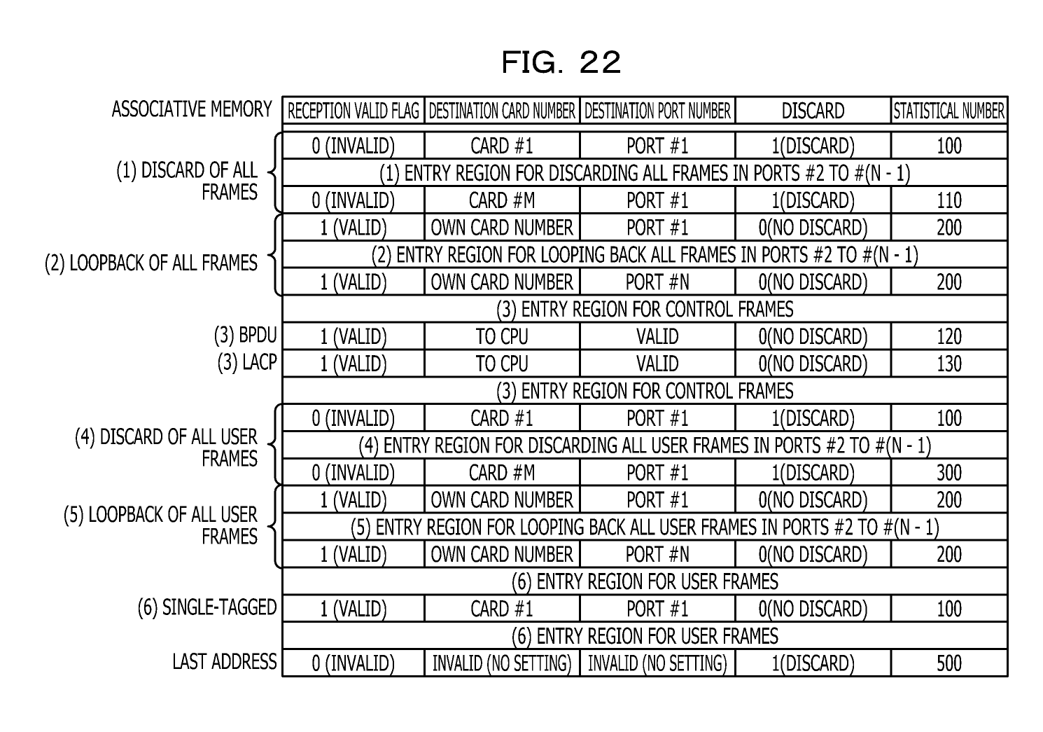

FIG. 22 is a diagram illustrating an example of entries in the associative memory 16f according to the sixth embodiment. In the sixth embodiment, statistical numbers are added to the entries in the associative memory 16f. The example of the associative memory 16f illustrated in FIG. 22 is obtained by adding the statistical numbers to the entries in the associative memory 16d (FIG. 19) according to the fourth embodiment. However, the associative memory 16f according to the sixth embodiment may be obtained by adding the statistical numbers to the entries in the associative memory 16 according to any of the first to third embodiments instead.

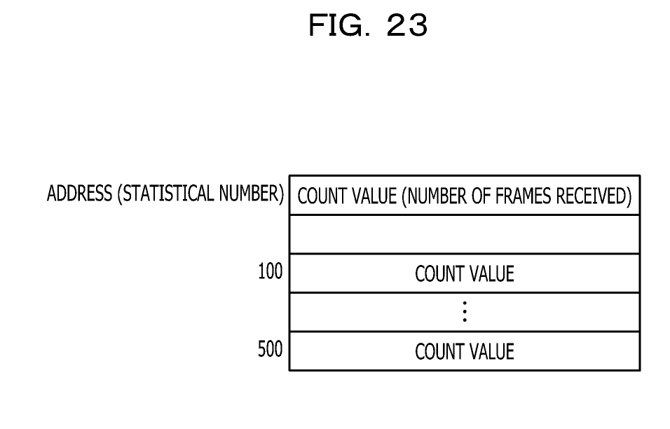

FIG. 23 is a diagram illustrating an example of the statistical information table 24f according to the sixth embodiment. The table indices of the statistical information table 24f according to the sixth embodiment are the statistical numbers in the associative memory 16f. That is, the addresses of the statistical information table 24f correspond to the statistical numbers.

In the sixth embodiment, the associative memory access control circuit 15 transmits the entries in the associative memory 16f found by a received frame to the statistical information collection circuit 23. The statistical information collection circuit 23 increases a count value stored in an address of the statistical information table 24f corresponding to a statistical number included in an entry in the associative memory 16f received from the associative memory access control circuit 15 by one.

When pieces of statistical information regarding a plurality of different entries in the associative memory 16f are to be collected in one operation, these pieces of statistical information can be obtained by setting a common statistical number to the plurality of difference entries. This holds true, for example, for a case in which pieces of statistical information regarding a plurality of user frames having a common VLAN ID are to be collected in one operation and a case in which the number of frames discarded by the line IF circuit 1f is to be collected in one operation.

In the sixth embodiment, the aggregate statistical information can be collected, and the software does not combine the individual pieces of statistical information. Therefore, the load on the software can be reduced. In the sixth embodiment, the aggregate statistical information is collected. Therefore, the size of the statistical information table 24f can be reduced. In a last address of the content-addressable memory 14a, an entry in which only masks are set is provided. Therefore, a received frame that does not match the entries other than the entry in the last address matches the entry in the last address. As a result, statistical information indicating that a frame other than the registered frames has been received can also be collected. For example, the communication apparatus 100 can collect statistical information indicating that a frame having an unintended VLAN ID has been received.

In a seventh embodiment, the action codes are not included in the entries in the content-addressable memory 14, and the judgment of the packet filtering using the results obtained by searching the content-addressable memory 14 is not performed. In the seventh embodiment, a circuit for executing the judgment of the packet filtering is newly added.

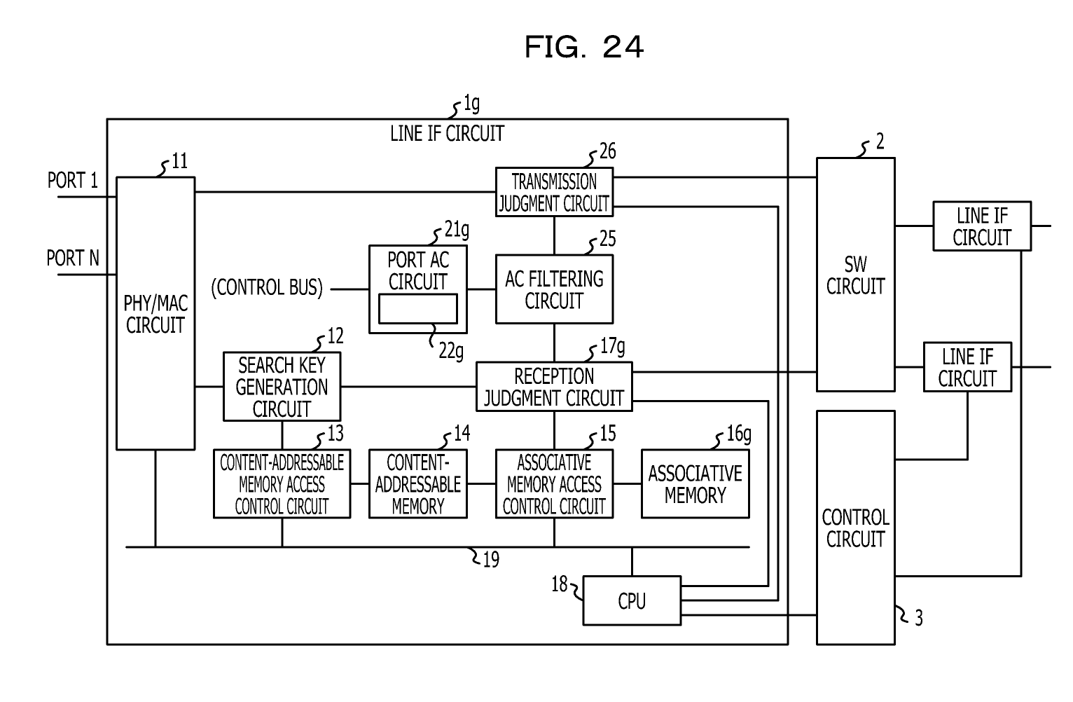

FIG. 24 is a diagram illustrating an example of a line IF circuit 1g according to the seventh embodiment. The line IF circuit 1g according to the seventh embodiment newly includes an AC filtering circuit 25 that executes the judgment of the packet filtering. FIG. 24 also illustrates a transmission judgment circuit 26, which is a circuit on the transmission side of the line IF circuit 1g. The configuration of the line IF circuit 1g according to the seventh embodiment is the same as that of the line IF circuit 1 illustrated in FIG. 5, except for an associative memory 16g, a reception judgment circuit 17g, a port AC circuit 21g, a port AC table 22g, the AC filtering circuit 25, and the transmission judgment circuit 26.

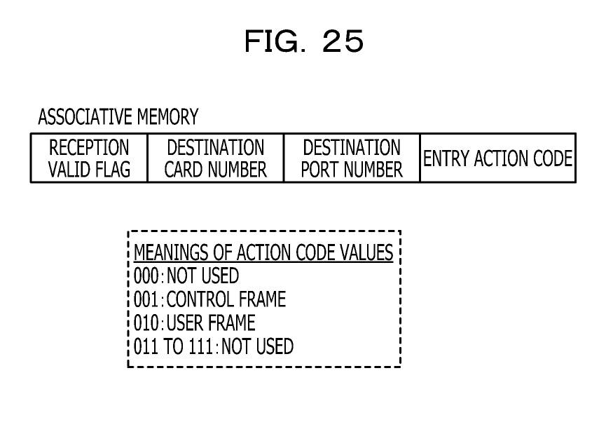

FIG. 25 is a diagram illustrating an example of an entry in the associative memory 16g according to the seventh embodiment. The entry in the associative memory 16g according to the seventh embodiment includes an entry action code in addition to the reception valid flag, the destination card number, and the destination port number. The entry action code is a code indicating whether a received frame is a user frame or a control frame.

When the entry action code value is “001”, the received frame is a control frame. When the entry action code value is “010”, the received frame is a user frame.

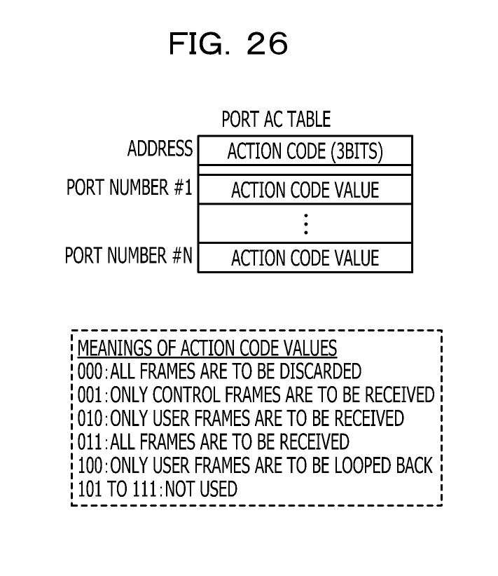

FIG. 26 is a diagram illustrating an example of the port AC table 22g according to the seventh embodiment. In the port AC table 22g, a port action code value is set for each port using the port numbers as the table indices. In the seventh embodiment, when the port action code value is “000”, all frames are to be discarded. When the port action code value is “001”, only control frames are to be received, that is, all user frames are to be discarded. When the port action code value is “010”, only user frames are to be received, that is, all control frames are to be discarded. When the port action code value is “011”, all frames are to be received. When the port action code value is “100”, only user frames are to be looped back.

In the seventh embodiment, a port action code value for specifying loopback of all frames does not exist for the following reason. Control frame include a control frame for specifying setting and cancel of loopback. If the loopback of all the frames is set for a port, the control frame for specifying the cancel of the loopback is also looped back, thereby making it difficult to cancel the loopback. This is why a port action code value for specifying loopback of all frames does not exist.

In the seventh embodiment, when the reception valid flag in an entry in the associative memory 16g corresponding to the received frame is valid (set to 1), the reception judgment circuit 17g transmits the entry in the associative memory 16g and the reception port number of the received frame to the AC filtering circuit 25. The AC filtering circuit 25 accesses the port AC circuit 21g on the basis of the received reception port number. The port AC circuit 21g reads a port action code value corresponding to the reception port number from the port AC table 22g and transmits the port action code value to the AC filtering circuit 25.

The AC filtering circuit 25 executes an AC filtering judgment process for judging whether or not to discard the received frame and whether or not to execute loopback on the basis of an entry action code value included in the entry in the associative memory 16g and the port action code value of the reception port. Results of the AC filtering judgment process executed by the AC filtering circuit 25 are transmitted to the reception judgment circuit 17g. The reception judgment circuit 17g executes a process relating to discard, transfer, or loopback of the received frame or the like on the basis of the results of the judgment made by the AC filtering circuit 25. In the seventh embodiment, when the received frame is to be looped back as a result of the AC filtering judgment process executed by the AC filtering circuit 25, the reception judgment circuit 17g transmits the received frame not to the SW circuit 2 but to the transmission judgment circuit 26.

The transmission judgment circuit 26 receives frames from the SW circuit 2, the reception judgment circuit 17g, and the CPU 18. The inputs from the SW circuit 2, the reception judgment circuit 17g, and the CPU 18 are achieved using different signal lines. Apparatus headers are provided for the frames received by the transmission judgment circuit 26. The transmission judgment circuit 26 transmits the received frames to ports indicated by the destination port numbers included in the apparatus headers provided for the received frames.

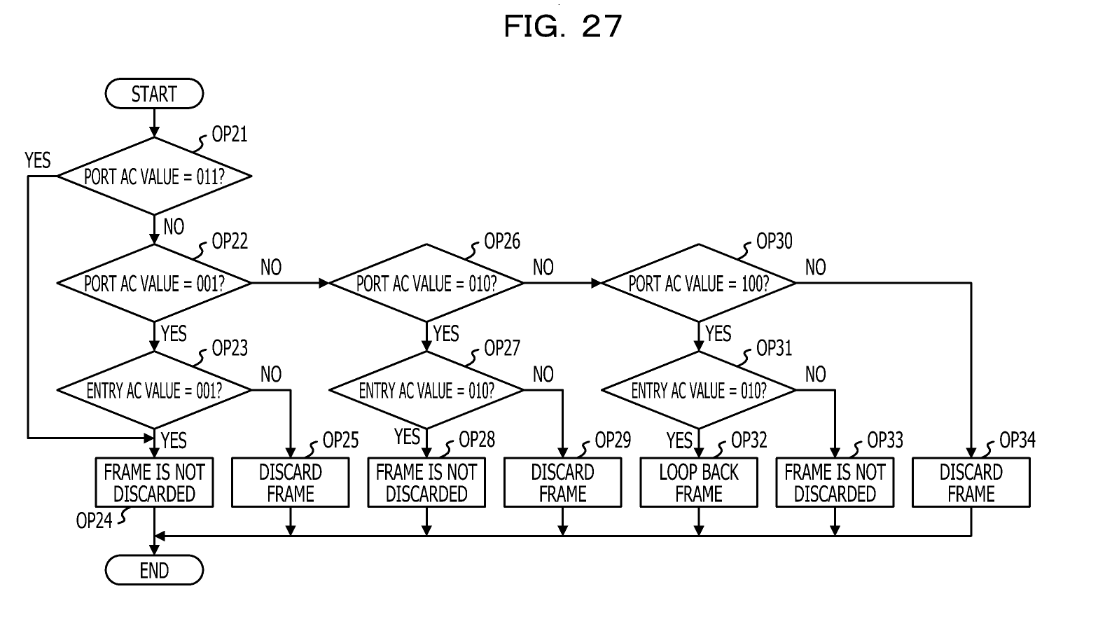

FIG. 27 is a flowchart illustrating an example of the AC filtering judgment process executed by the AC filtering circuit 25 on a received frame. The flowchart of FIG. 27 begins when the AC filtering circuit 25 has received an entry in the associative memory 16g and a port action code value corresponding to a reception port number. The action code values will be denoted as the “AC values” hereinafter.

In OP21, the AC filtering circuit 25 judges whether or not the port AC value of the reception port is 011. If the port AC value of the reception port is 011 (YES in OP21), the reception port is to receive all frames. In this case, the AC filtering circuit 25 determines not to discard the received frame (OP24). Thereafter, the flowchart of FIG. 27 ends. If the port AC value of the reception port is not 011 (NO in OP21), the process proceeds to OP22.

In OP22, the AC filtering circuit 25 judges whether or not the port AC value of the reception port is 001. If the port AC value of the reception port is 001 (YES in OP22), the reception port is to receive only control frames. In this case, the process proceeds to OP23. If the port AC value of the reception port is not 001 (NO in OP22), the process proceeds to OP26.

In OP23, the AC filtering circuit 25 judges whether or not an entry AC value included in an entry in the associative memory 16g detected for the received frame is 001. If the entry AC value is 001 (YES in OP23), the received frame is a control frame. Therefore, the AC filtering circuit 25 determines not to discard the received frame (OP24). Thereafter, the flowchart of FIG. 27 ends. If the entry AC value is not 001, that is, if it is not clearly indicated that the received frame is a control frame (NO in OP23), the AC filtering circuit 25 determines to discard the received frame (OP25). Thereafter, the flowchart of FIG. 27 ends.

In OP26, the AC filtering circuit 25 judges whether or not the port AC value of the reception port is 010. If the port AC value of the reception port is 010 (YES in OP26), the reception port is to receive only user frames. In this case, the process proceeds to OP27. If the port AC value of the reception port is not 010 (NO in OP26), the process proceeds to OP30.

In OP27, the AC filtering circuit 25 judges whether or not an entry AC value included in an entry in the associative memory 16g detected for the received frame is 010. If the entry AC value is 010 (YES in OP27), the received frame is a user frame. Therefore, the AC filtering circuit 25 determines not to discard the received frame (OP28). Thereafter, the flowchart of FIG. 27 ends. If the entry AC value is not 010, that is, if it is not clearly indicated that the received frames is a user frame (NO in OP27), the AC filtering circuit 25 determines to discard the received frame (OP29). Thereafter, the flowchart of FIG. 27 ends.

In OP30, the AC filtering circuit 25 judges whether or not the port AC value of the reception port is 100. If the port AC value of the reception port is 100 (YES in OP30), the reception port is to loop back only user frames. In this case, the process proceeds to OP31. If the port AC value of the reception port is not 100 (NO in OP30), the AC filtering circuit 25 determines to discard the received frame (OP34). Thereafter, the flowchart of FIG. 27 ends.

In OP31, the AC filtering circuit 25 judges whether or not an entry AC value included in an entry in the associative memory 16g detected for the received frame is 010. If the entry AC value is 010 (YES in OP31), the received frame is a user frame. Therefore, the AC filtering circuit 25 determines to loop back the received frame (OP32). Thereafter, the flowchart of FIG. 27 ends. If the entry AC value is not 010, that is, if it is not clearly indicated that the received frame is a user frame (NO in OP31), the AC filtering circuit 25 determines not to discard the received frame (OP33). Thereafter, the flowchart of FIG. 27 ends.

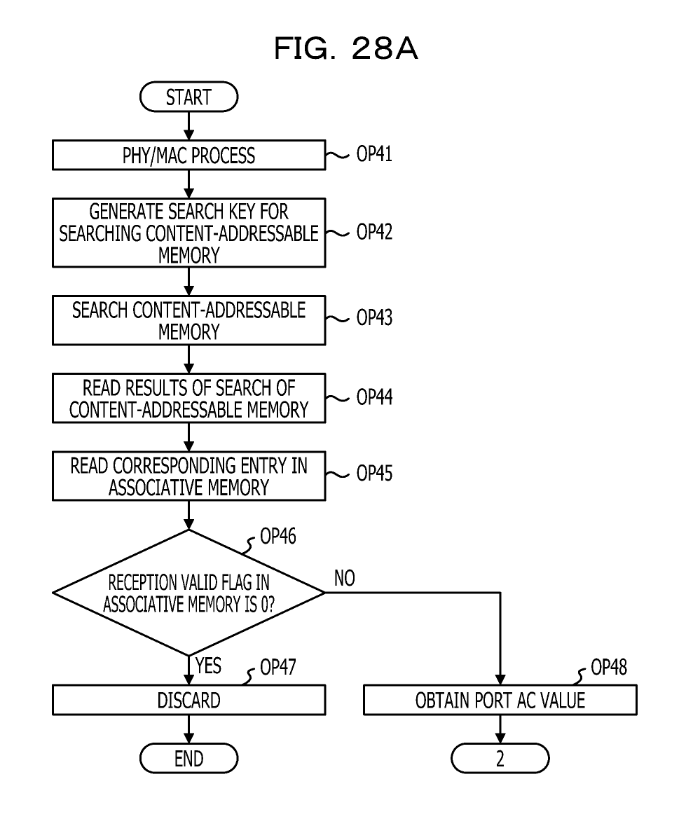

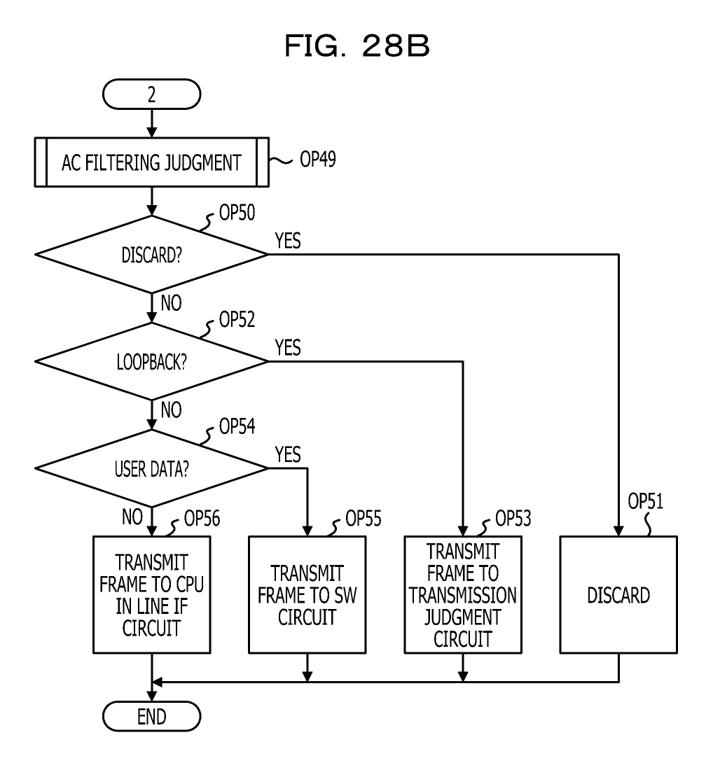

FIGS. 28A and 28B are flowcharts illustrating examples of a process for receiving a frame executed by the line IF circuit 1g according to the seventh embodiment. The flowcharts of FIGS. 28A and 28B begin when the line IF circuit 1g has received a frame.

In OP41, the received frame is subjected to the termination process in the physical layer and the MAC layer thereof executed by the PHY/MAC circuit 11. For example, in the MAC layer, an FCS check is performed. If an error has been found in the received frame by the FCS check, the received frame is discarded. If no error has been found in the received frame by the FCS check, the process proceeds to OP42.

In OP42, the search key generation circuit 12 generates a search key of the received frame for searching the content-addressable memory 14a. The search key generation circuit 12 generates the search key by combining the reception port number of a port that has received the frame and the 20-byte data from the top of the received frame. The search key is transmitted to the content-addressable memory access control circuit 13. The process then proceeds to OP43.

In OP43, the content-addressable memory access control circuit 13 searches the content-addressable memory 14 using the search key of the received frame. The process then proceeds to OP44.

In OP44, an address obtained by searching the content-addressable memory 14 using the search key of the received frame is output from the content-addressable memory 14 to the associative memory access control circuit 15. The process then proceeds to OP45.

In OP45, the associative memory access control circuit 15 reads an entry corresponding to the received address from the associative memory 16g. The associative memory access control circuit 15 transmits the read entry in the associative memory 16g to the reception judgment circuit 17g. The process then proceeds to OP46.

In OP46, the reception judgment circuit 17g judges whether or not the reception valid flag of the entry in the associative memory 16g detected for the received frame is 0, that is, whether or not the received frame is allowed to be received. If the reception valid flag is 0 (YES in OP46), the process proceeds to OP47. If the reception valid flag is 1 (NO in OP46), the process proceeds to OP48.

In OP47, since the reception valid flag of the entry in the associative memory 16 detected for the received frame is 0, reception of the received frame is rejected. Therefore, the received frame is discarded. Thereafter, the flowchart of FIG. 28A ends.

In OP48, the reception judgment circuit 17g transmits the entry in the associative memory 16g and the reception port number of the received frame to the AC filtering circuit 25. The AC filtering circuit 25 accesses the port AC circuit 21g using the reception port number and obtains a port AC value set for the reception port. Next, the process proceeds to OP 49.

In OP49, the AC filtering circuit 25 executes the AC filtering judgment process. The AC filtering judgment process is, for example, the process illustrated by the flowchart of FIG. 27. The AC filtering circuit 25 transmits results of the AC filtering judgment process to the reception judgment circuit 17g. Next, the process proceeds to OP50.

In OP50, the reception judgment circuit 17g judges whether or not the results of the AC filtering judgment process indicate discard of the received frame. If the results of the AC filtering judgment process indicate discard of the received frame (YES in OP50), the process proceeds to OP51. If the results of the AC filtering judgment process do not indicate discard of the received frame (NO in OP50), the process proceeds to OP52.

In OP51, since the results of the AC filtering judgment process indicate discard of the received frame, the reception judgment circuit 17g discards the received frame. Thereafter, the flowchart of FIG. 28B ends.

In OP52, the reception judgment circuit 17g judges whether or not the results of the AC filtering judgment process indicate loopback of the received frame. If the results of the AC filtering judgment process indicate loopback of the received frame (YES in OP52), the process proceeds to OP53. If the results of the AC filtering judgment process do not indicate loopback of the received frame (NO in OP52), the process proceeds to OP54.

In OP53, the reception judgment circuit 17g adds, to the received frame, an apparatus header in which the destination card number is the card number of the line IF circuit 1g itself and the destination port number is the reception port number of the received frame and transmits the received frame to the transmission judgment circuit 26. The received frame is transmitted by the transmission judgment circuit 26 to a port indicated by the destination port number in the apparatus header and output from the port. Thereafter, the flowchart of FIG. 28B ends.

In OP54, the reception judgment circuit 17g judges whether or not the received frame is a user frame. This judgment may be made on the basis of the entry AC value in the entry of the received frame in the associative memory 16g or may be made by judging whether or not the destination card of the entry in the associative memory 16g is the CPU 18. If the received frame is a user frame (YES in OP54), the process proceeds to OP55. If the received frame is not a user frame (NO in OP54), the process proceeds to OP56.

In OP55, the received frame is transmitted to the SW circuit 2 by the reception judgment circuit 17g. At this time, the reception judgment circuit 17g transmits the received frame to the SW circuit 2 after adding, to the received frame, an apparatus header including the destination card number and the destination port number of the entry in the associative memory 16 detected for the received frame. Thereafter, the flowchart of FIG. 28B ends.

In OP56, since the received frame is a control frame, the reception judgment circuit 17g transmits the received frame to the CPU 18. Thereafter, the flowchart of FIG. 28B ends.

In the seventh embodiment, too, by changing the port AC value for each port, the setting of the packet filtering can be changed without adding, deleting, or changing the entries in the content-addressable memory 14 and the associative memory 16g. In the seventh embodiment, when the received frame is to be looped back, the reception judgment circuit 17g does not transmit the received frame to the SW circuit 2 but directly transmits the received frame to the transmission judgment circuit 26. However, as with the third embodiment, the reception judgment circuit 17g may transmit the received frame to the SW circuit 2 instead when the received frame is to be looped back.

In an eighth embodiment, the communication apparatus 100 executes packet filtering in units of VLANs.

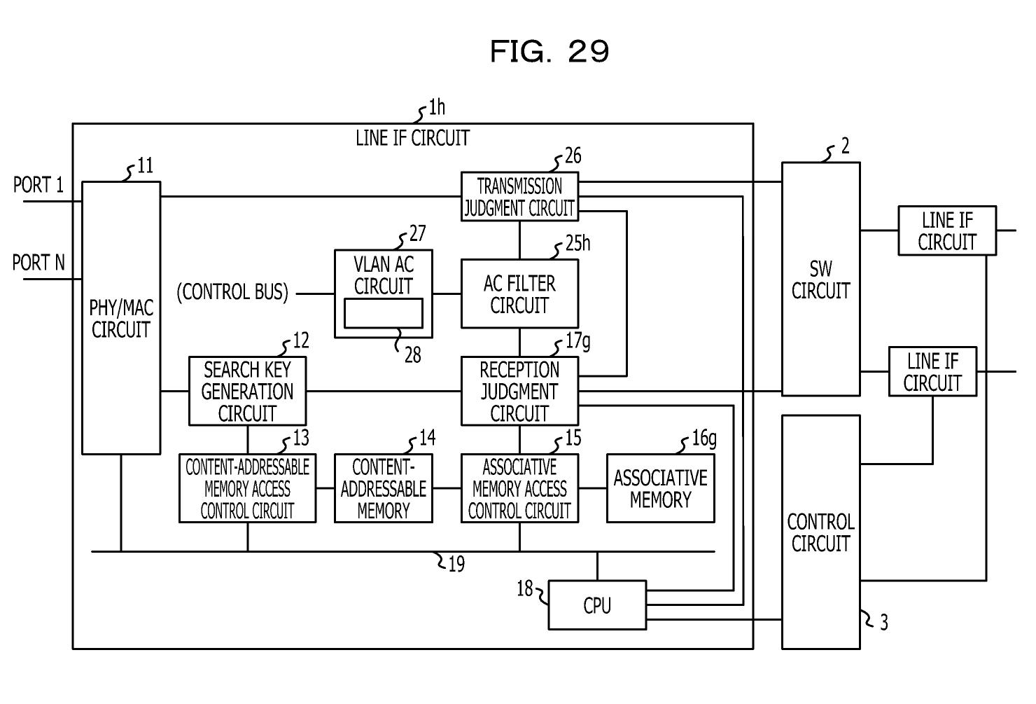

FIG. 29 is a diagram illustrating an example of a line IF circuit 1h according to the eighth embodiment. The line IF circuit 1h according to the eighth embodiment newly includes a VLAN AC circuit 27. The configuration of the line IF circuit 1h according to the eighth embodiment is the same as that of the line IF circuit 1g according to the seventh embodiment, except for the VLAN AC circuit 27 and an AC filtering circuit 25h.

The AC filtering circuit 25h accesses the VLAN AC circuit 27 on the basis of a VLAN ID included in a frame received from the reception judgment circuit 17g. The VLAN AC circuit 27 has a VLAN AC table 28 in a memory included therein. The VLAN AC table 28 holds VLAN action code values corresponding to VLAN IDs. The VLAN AC circuit 27 reads a VLAN action code value corresponding to a VLAN ID included in a VLAN tag of the received frame from the VLAN AC table 28 and transmits the VLAN action code value to the AC filtering circuit 25h. The AC filtering circuit 25h executes an AC filtering judgment process on the received frame on the basis of the VLAN AC value received from the VLAN AC circuit 27 and the entry of the received frame in the associative memory 16g. When two or more VLAN tags are included in the received frame, for example, the VLAN AC circuit 27 reads, from the VLAN AC table 28, a VLAN AC value corresponding to a VLAN ID included in an outermost VLAN tag.

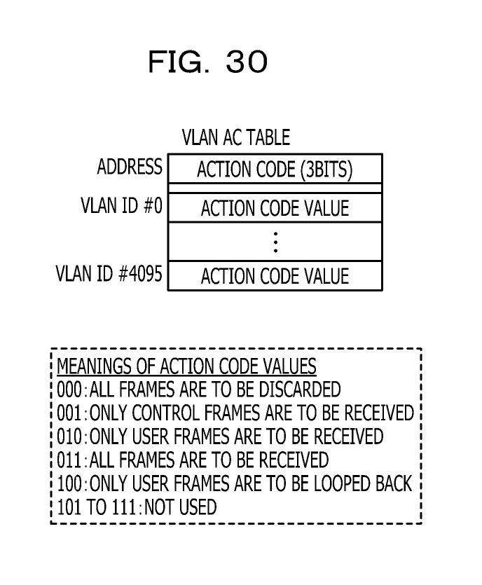

FIG. 30 is a diagram illustrating an example of the VLAN AC table 28. In the VLAN AC table 28, VLAN action codes are set for VLAN IDs using the VLAN IDs as table indices. That is, the addresses of the VLAN AC table 28 correspond to the VLAN IDs. When the VLAN AC value is “000”, all received frames in a corresponding VLAN are to be discarded. When the VLAN AC value is “001”, only control frames among received frames in a corresponding VLAN are to be received. When the VLAN AC value is “010”, only user frames among received frames in a corresponding VLAN are to be received. When the VLAN AC value is “011”, all received frames in a corresponding VLAN are to be received. When the VLAN AC value is “100”, only user frames among received frames in a corresponding VLAN are to be looped back. The reason why a VLAN AC value for specifying loopback of all frames does not exist is the same as the reason why a port AC value for specifying loopback of all frames does not exist, which has been described above.

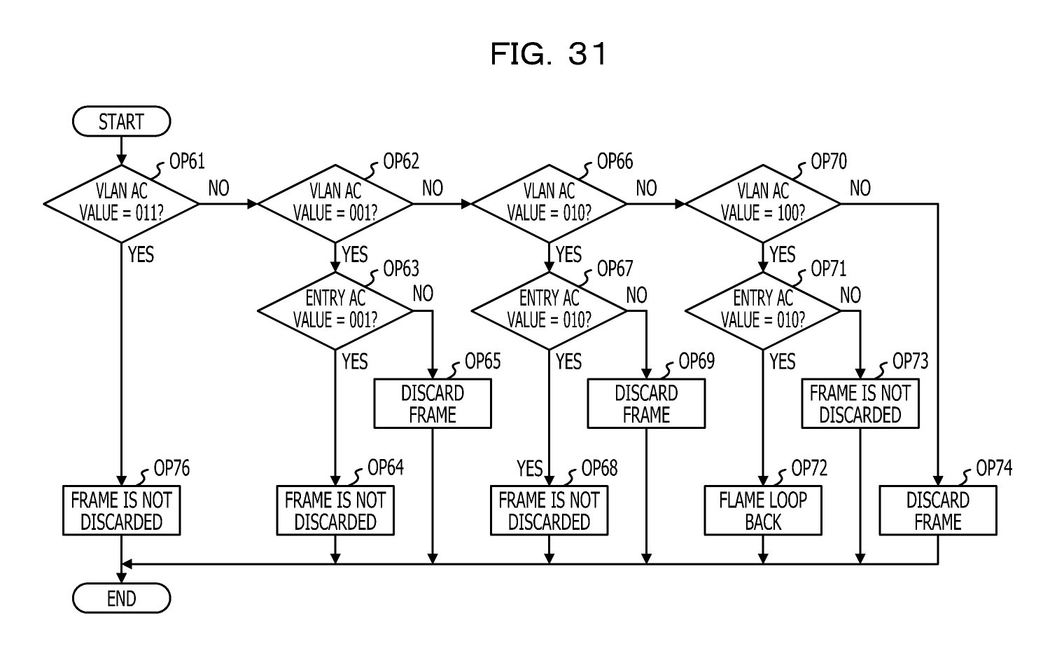

FIG. 31 is a flowchart illustrating an example of the AC filtering judgment process executed by the AC filtering circuit 25h according to the eighth embodiment. The flowchart of FIG. 31 begins when the AC filtering circuit 25h has received an entry in the associative memory 16g and the VLAN AC value of a received frame.

In OP61, the AC filtering circuit 25h judges whether or not the VLAN AC value of a received frame is 011. If the VLAN AC value is 011 (YES in OP61), a VLAN indicated by the received frame is to receive all received frames, and the AC filtering circuit 25h determines not to discard the received frame (OP76). Thereafter, the flowchart of FIG. 31 ends. If the VLAN AC value is not 011 (NO in OP61), the process proceeds to OP62.

In OP62, the AC filtering circuit 25h judges whether or not the VLAN AC value of the received frame is 001. If the VLAN AC value is 001 (YES in OP62), a VLAN indicated by the received frame is to receive only control frames. In this case, the process proceeds to OP63. If the VLAN AC value is not 001 (NO in OP62), the process proceeds to OP66.

In OP63, the AC filtering circuit 25h judges whether or not an entry AC value included in the entry in the associative memory 16g detected for the received frame is 001. If the entry AC value is 001 (YES in OP63), the received frame is a control frame, and therefore the AC filtering circuit 25h determines not to discard the received frame (OP64). Thereafter, the flowchart of FIG. 31 ends. If the entry AC value is not 001, that is, if it is not clearly indicated that the received frame is a control frame (NO in OP63), the AC filtering circuit 25h determines to discard the received frame (OP65). Thereafter, the flowchart of FIG. 31 ends.

In OP66, the AC filtering circuit 25h judges whether or not the VLAN AC value of the received frame is 010. If the VLAN AC value is 010 (YES in OP66), a VLAN indicated by the received frame is to receive only user frames. In this case, the process proceeds to OP67. If the VLAN AC value is not 010 (NO in OP66), the process proceeds to OP70.

In OP67, the AC filtering circuit 25h judges whether or not an entry AC value included in the entry in the associative memory 16g detected for the received frame is 010. If the entry AC value is 010 (YES in OP67), the received frame is a user frame, and therefore the AC filtering circuit 25h determines not to discard the received frame (OP68). Thereafter, the flowchart of FIG. 31 ends. If the entry AC value is not 010, that is, if it is not clearly indicated that the received frame is a user frame (NO in OP67), the AC filtering circuit 25h determines to discard the received frame (OP69). Thereafter, the flowchart of FIG. 31 ends.

In OP70, the AC filtering circuit 25h judges whether or not the VLAN AC value of the received frame is 100. If the VLAN AC value is 100 (YES in OP70), a VLAN indicated by the received frame is to loop back only user frames. In this case, the process proceeds to OP71. If the VLAN AC value is not 100 (NO in OP70), the AC filtering circuit 25h determines to discard the received frame (OP74). Thereafter, the flowchart of FIG. 31 ends.

In OP71, the AC filtering circuit 25h judges whether or not an entry AC value included in the entry in the associative memory 16g detected for the received frame is 010. If the entry AC value is 010 (YES in OP71), the received frame is a user frame, and therefore the AC filtering circuit 25h determines to loop back the received frame (OP72). Thereafter, the flowchart of FIG. 31 ends. If the entry AC value is not 010, that is, if it is not clearly indicated that the received frame is a user frame (NO in OP71), the AC filtering circuit 25h determines not to discard the received frame (OP73). Thereafter, the flowchart of FIG. 31 ends.

When the AC filtering judgment process executed by the AC filtering circuit 25h illustrated by the flowchart of FIG. 31 ends, results of the AC filtering judgment process are transmitted to the reception judgment circuit 17g. The reception judgment circuit 17g, for example, discards, transfers, or loops back the received frame on the basis of the results of the AC filtering judgment process as in the seventh embodiment (refer to FIG. 28B).

According to the eighth embodiment, the packet filtering can be set in units of VLANs. In addition, by setting the VLAN AC value for each VLAN, the packet filtering can be set in units of VLANs without adding, deleting, or changing the entries in the content-addressable memory 14 and the associative memory 16g.

In a ninth embodiment, the communication apparatus 100 uses both packet filtering in units of ports and packet filtering in units of VLANs.

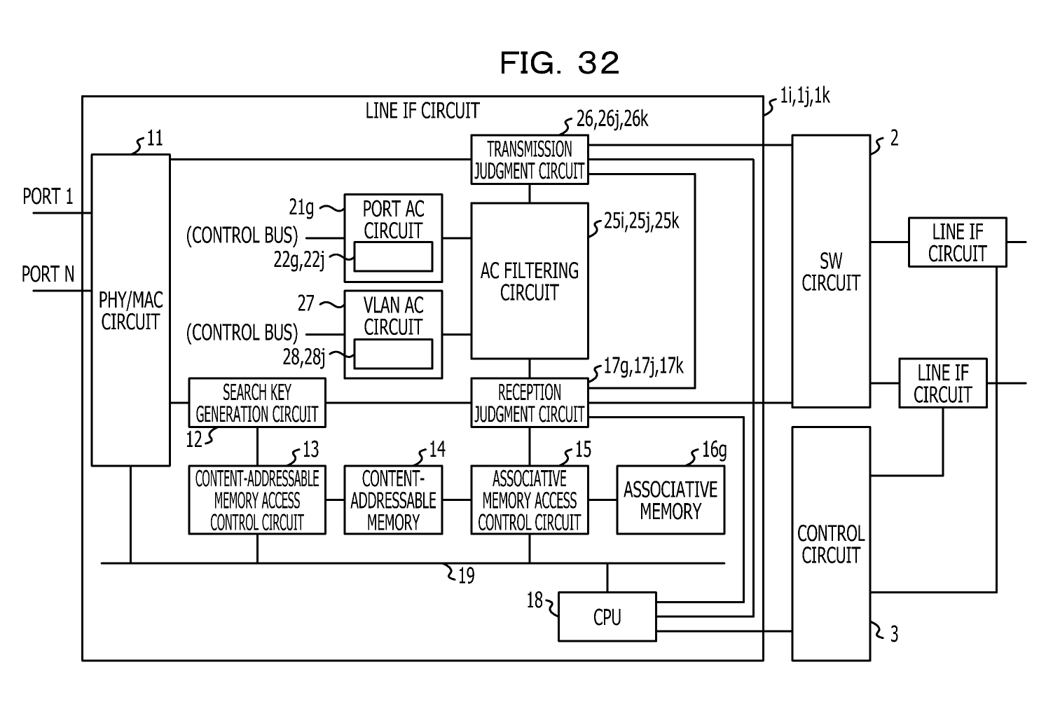

FIG. 32 is a diagram illustrating an example of a line IF circuit 1i according to the ninth embodiment. The line IF circuit 1i according to the ninth embodiment has both the port AC circuit 21g and the VLAN AC circuit 27. The configuration of the line IF circuit 1i is the same as that of the line IF circuit 1g according to the seventh embodiment and that of the line IF circuit 1h according to the eighth embodiment, except for the combination between the port AC circuit 21g and the VLAN AC circuit 27, and an AC filtering circuit 25i.

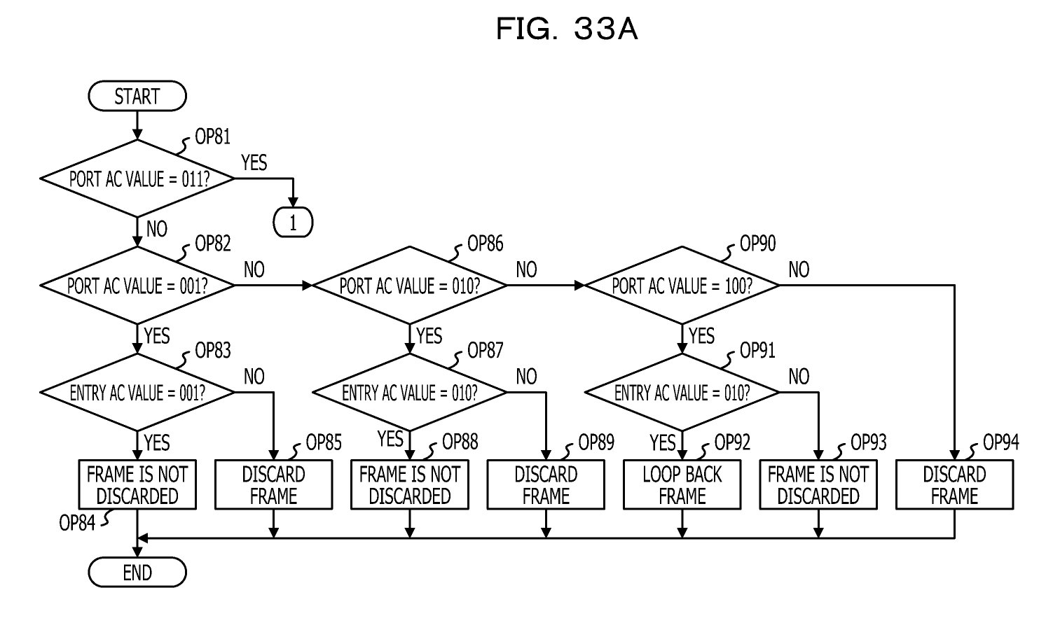

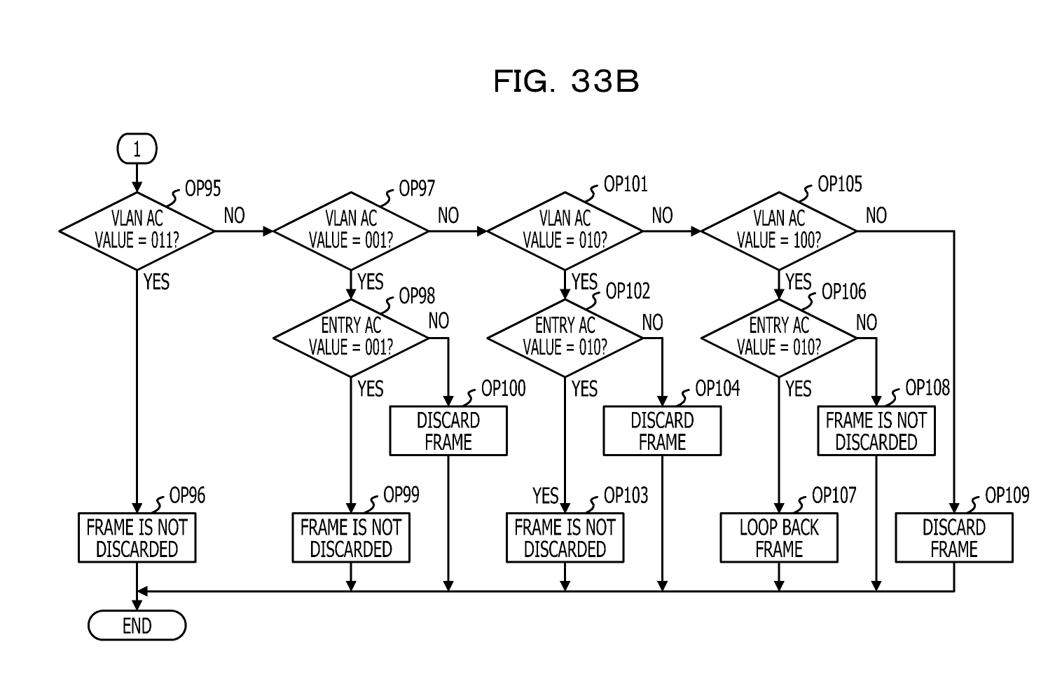

FIGS. 33A and 33B are flowcharts illustrating an example of an AC filtering judgment process executed by the AC filtering circuit 25i according to the ninth embodiment. The flowcharts of FIGS. 33A and 33B begin when the AC filtering circuit 25i has received an entry of a received frame in the associative memory 16g, the port AC value of a reception port, and the VLAN AC value of the received frame.

In OP81, the AC filtering circuit 25i judges whether or not the port AC value of the reception port is 011. If the port AC value of the reception port is 011 (YES in OP81), the reception port is to receive all frames. In this case, the process proceeds to OP95. If the port AC value of the reception port is not 011 (NO in OP81), the process proceeds to OP82.

Processing in OP82 to OP94 are the same AC filtering judgment process based on the port AC value and the entry AC value as the processing in the OP22 to OP34 illustrated in the flowchart of FIG. 27, and therefore description thereof is omitted.

Processing in OP95 to OP109 is the same AC filtering judgment process based on the VLAN AC value and the entry AC value as the processing in OP61 to OP74 illustrated in the flowchart of FIG. 31, and therefore description thereof is omitted.

In the AC filtering judgment process illustrated in FIGS. 33A and 33B, the port AC value has priority, and when the port AC value is 011 (all frames are to be received), the AC filtering judgment process based on the VLAN AC value is performed. However, when the AC filtering judgment process is performed using the port AC value, the VLAN AC value, and the entry AC value, either the port AC value or the VLAN AC value may have priority instead in accordance with the intention of a network manager.

According to the ninth embodiment, both the packet filtering in units of ports and the packet filtering in units of VLANs can be used. In this case, too, by setting the port AC value for each port and the VLAN AC value for each VLAN, the packet filtering can be set without adding, deleting, or changing the entries in the content-addressable memory 14 and the associative memory 16g.

In a tenth embodiment, the communication apparatus 100 executes the packet filtering of a received frame on a frame to be transmitted from a port to a line, that is, the packet filtering of a received frame is performed in a process for transmitting a frame. In the tenth embodiment, the configuration of a line IF circuit 1j is the same as that of the line IF circuit 1i according to the ninth embodiment, except for a reception judgment circuit 17j, an AC filtering circuit 25j, and a transmission judgment circuit 26j (refer to FIG. 32).

In the tenth embodiment, the reception judgment circuit 17j receives an entry of a received frame in the associative memory 16g from the associative memory access control circuit 15. The reception judgment circuit 17j judges whether or not to discard the received frame on the basis of a reception valid flag included in the received entry in the associative memory 16g. In the tenth embodiment, at this time, the AC filtering circuit 25j does not execute the AC filtering judgment process. When the reception valid flag included in the received entry in the associative memory 16g is 1 (valid), the reception judgment circuit 17j adds an apparatus header to the received frame and transmits the received frame to the SW circuit 2. At this time, the reception judgment circuit 17j adds an entry AC value included in the entry of the received frame in the associative memory 16g to the apparatus header.

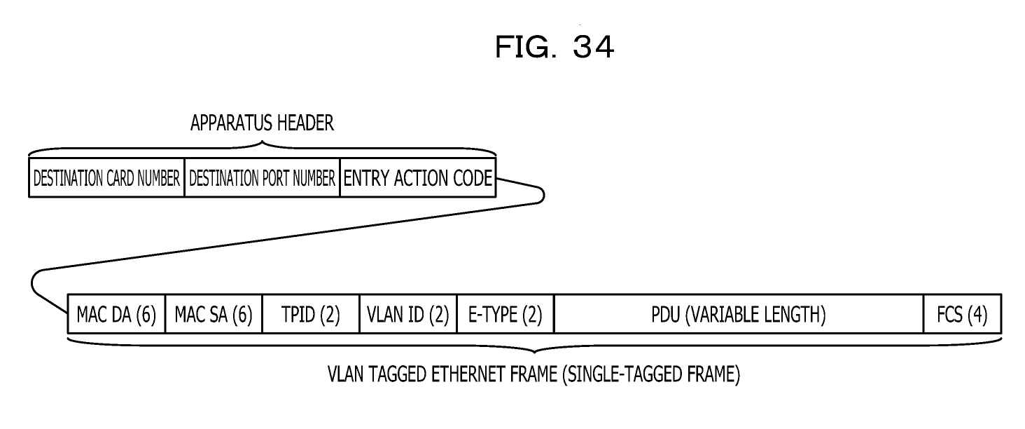

FIG. 34 is a diagram illustrating the format of an Ethernet frame to which an apparatus header according to the tenth embodiment has been added. In the tenth embodiment, the apparatus header includes the destination card number, the destination port number, and the entry AC value. As the destination card number, the destination port number, and the entry AC value, values included in the entry of the received frame in the associative memory 16g are used. Although FIG. 34 illustrates an example in which the apparatus header has been added to a VLAN single-tagged Ethernet frame, the present disclosure is not limited to this. The apparatus header illustrated in FIG. 34 can be added to a VLAN untagged Ethernet frame or an Ethernet frame to which two or more VLAN tags have been provided.

The transmission judgment circuit 26j receives the frame to which the apparatus header illustrated in FIG. 34 has been added from the SW circuit 2. The transmission judgment circuit 26j transmits the destination port number, the entry AC value, and the VLAN ID included in the received frame to the AC filtering circuit 25j. For example, the transmission judgment circuit 26j may transmit 20-byte data (includes the apparatus header to the second VLAN tag) from the top of the received frame to the AC filtering circuit 25j.

The AC filtering circuit 25j accesses the port AC circuit 21g using the destination port number received from the transmission judgment circuit 26j and obtains a port AC value corresponding to the destination port number. In addition, the AC filtering circuit 25j accesses the VLAN AC circuit 27 using the VLAN ID received from the transmission judgment circuit 26j and obtains a VLAN AC value corresponding to the VLAN ID. The AC filtering circuit 25j executes the AC filtering judgment process on the basis of the entry AC value, the port AC value, and the VLAN AC value. Results of the AC filtering judgment process executed by the AC filtering circuit 25j are transmitted to the transmission judgment circuit 26j. The transmission judgment circuit 26j, for example, discards or transfers the frame on the basis of the results of the judgment made by the AC filtering circuit 25j.

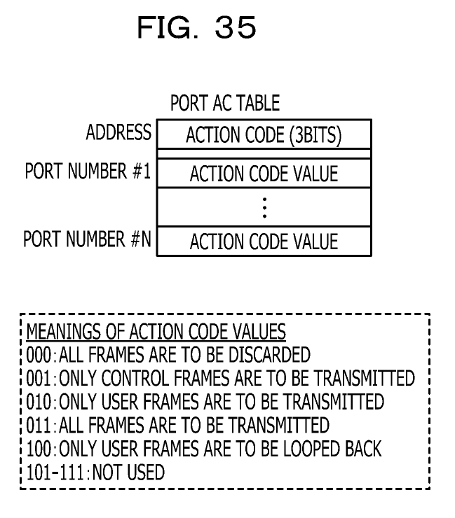

FIG. 35 is a diagram illustrating an example of a port AC table 22j according to the tenth embodiment. In the port AC table 22j, the port AC values are set for ports using the port numbers as table indices. When the port AC value according to the tenth embodiment is “000”, all frames are to be discarded. When the port AC value is “001”, only control frames are to be transmitted, that is, all user frames are to be discarded. When the port AC value is “010”, only user frames are to be transmitted, that is, all control frames are to be discarded. When the port AC value is “011”, all frames are to be transmitted. When the port AC value is “100”, only user frames are to be looped back. However, in the tenth embodiment, the port AC value “100” is not used. That is, in the tenth embodiment, loopback is not performed (loopback will be described later in an eleventh embodiment).

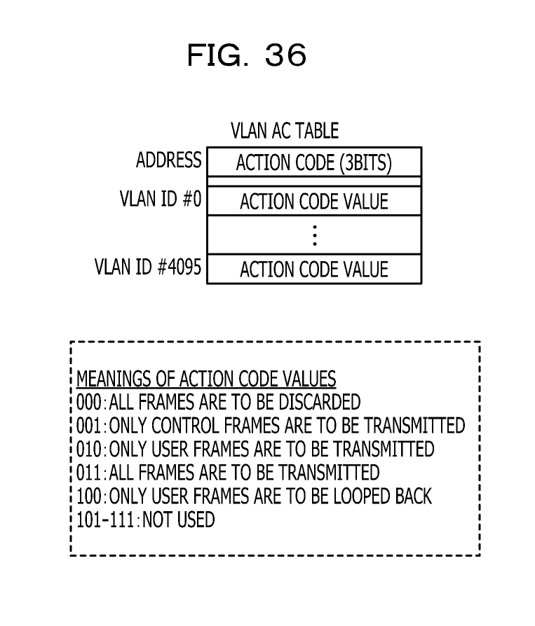

FIG. 36 is a diagram illustrating an example of a VLAN AC table 28j according to the tenth embodiment. In the VLAN AC table 28j, VLAN action code values are set for VLAN IDs using the VLAN IDs as table indices. When the VLAN AC value is “000”, all frames in a corresponding VLAN are to be discarded. When the VLAN AC value is “001”, only control frames among frames in a corresponding VLAN are to be transmitted. When the VLAN AC value is “010”, only user frames among frames in a corresponding VLAN are to be transmitted. When the VLAN AC value is “011”, all frames in a corresponding VLAN are to be transmitted. When the VLAN AC value is “100”, only user frames among frames to be transmitted in a corresponding VLAN are to be looped back. However, in the tenth embodiment, the VLAN AC value “100” is not used. That is, in the tenth embodiment, loopback is not performed (loopback will be described later in the eleventh embodiment). The reason why a port AC value and a VLAN AC value for specifying loopback of all frames do not exist in the tenth embodiment is the same as the reason why a port AC value for specifying loopback of all frames does not exist in the seventh embodiment.

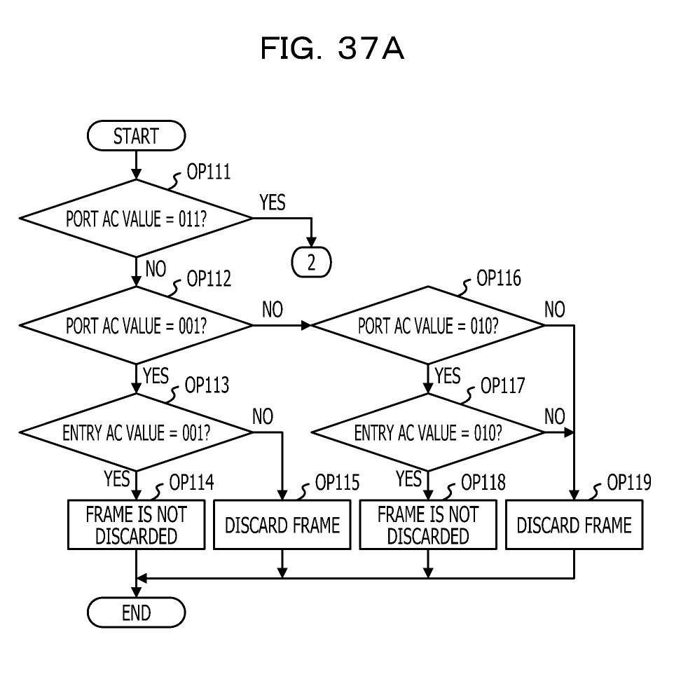

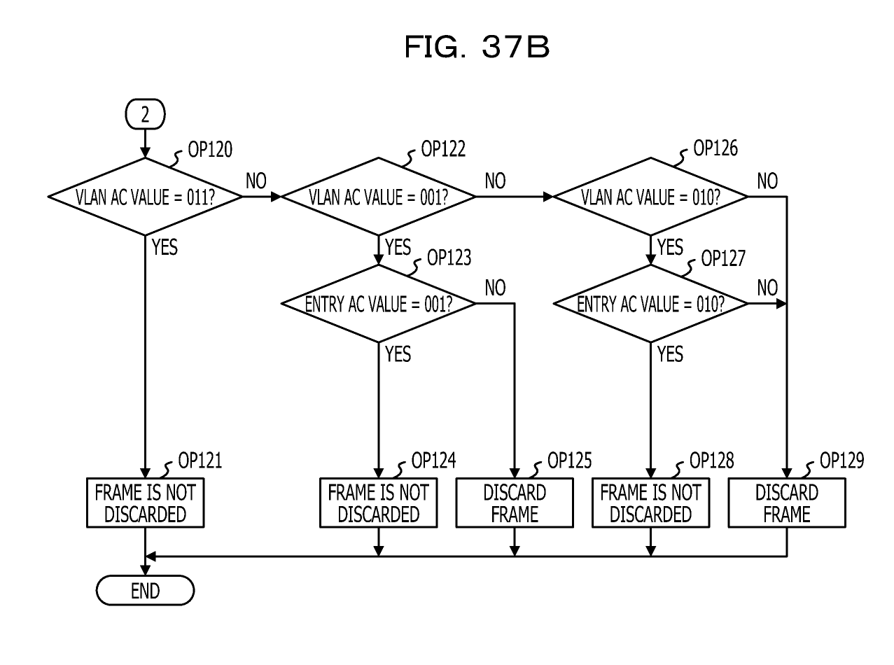

FIGS. 37A and 37B are flowcharts illustrating an example of an AC filtering judgment process executed by the AC filtering circuit 25j according to the tenth embodiment. The flowcharts of FIGS. 37A and 37B begin when the AC filtering circuit 25j has received a port AC value, a VLAN AC value, and an entry AC value corresponding to a frame received from the SW circuit 2.

In OP111, the AC filtering circuit 25j judges whether or not the port AC value corresponding to a destination port number included in an apparatus header of the frame received from the SW circuit 2 is 011. If the port AC value is 011 (YES in OP111), all frames are to be transmitted from the destination port. In this case, the process proceeds to OP120. If the port AC value is not 011 (NO in OP111), the process proceeds to OP112.

In OP112, the AC filtering circuit 25j judges whether or not the port AC value corresponding to the destination port number included in the apparatus header of the frame received from the SW circuit 2 is 001. If the port AC value is 001 (YES in OP112), only control frames are to be transmitted from the destination port. In this case, the process proceeds to OP113. If the port AC value is not 001 (NO in OP112), the process proceeds to OP116.

In OP113, the AC filtering circuit 25j judges whether or not the entry AC value included in the apparatus header of the frame received from the SW circuit 2 is 001. If the entry AC value is 001 (YES in OP113), since the frame received from the SW circuit 2 is a control frame, the AC filtering circuit 25j determines not to discard the frame (OP114). Thereafter, the flowchart of FIG. 37A ends. If the entry AC value is not 001, that is, if it is not clearly indicated that the frame received from the SW circuit 2 is a control frame (NO in OP113), the AC filtering circuit 25j determines to discard the frame (OP115). Thereafter, the flowchart of FIG. 37A ends.

In OP116, the AC filtering circuit 25j judges whether or not the port AC value corresponding to the destination port number included in the apparatus header of the frame received from the SW circuit 2 is 010. If the port AC value is 010 (YES in OP116), only user frames are to be transmitted from the destination port. In this case, the process proceeds to OP117. If the port AC value is not 010 (NO in OP116), the AC filtering circuit 25j determines to discard the frame received from the SW circuit 2 (OP119). Thereafter, the flowchart of FIG. 37A ends.

In OP117, the AC filtering circuit 25j judges whether or not the entry AC value included in the apparatus header of the frame received from the SW circuit 2 010. If the entry AC value is 010 (YES in OP117), since the frame received from the SW circuit 2 is a user frame, the AC filtering circuit 25j determines not to discard the frame (OP118). Thereafter, the flowchart of FIG. 37A ends. If the entry AC value is not 010, that is, if it is not clearly indicated that the frame received from the SW circuit 2 is a user frame (NO in OP117), the AC filtering circuit 25j determines to discard the frame (OP119). Thereafter, the flowchart of FIG. 37A ends.

In OP120, the AC filtering circuit 25j judges whether or not the VLAN AC value of the frame received from the SW circuit 2 is 011. If the VLAN AC value is 011 (YES in OP120), all frames are to be transmitted in a VLAN to which the frame received from the SW circuit 2 belongs, and the AC filtering circuit 25 determines not to discard the frame (OP121). Thereafter, the flowchart of FIG. 37B ends. If the VLAN AC value is not 011 (NO in OP120), the process proceeds to OP122.

In OP122, the AC filtering circuit 25j judges whether or not the VLAN AC value of the frame received from the SW circuit 2 is 001. If the VLAN AC value is 001 (YES in OP122), only control frames are to be transmitted in the VLAN to which the frame received from the SW circuit 2 belongs. In this case, the process proceeds to OP123. If the VLAN AC value is not 001 (NO in OP122), the process proceeds to OP126.

In OP123, the AC filtering circuit 25j judges whether or not the entry AC value included in the apparatus header of the frame received from the SW circuit 2 is 001. If the entry AC value is 001 (YES in OP123), since the frame received from the SW circuit 2 is a control frame, the AC filtering circuit 25j determines not to discard the frame (OP124). Thereafter, the flowchart of FIG. 37B ends. If the entry AC value is not 001, that is, if it is not clearly indicated that the frame received from the SW circuit 2 is a control frame (NO in OP123), the AC filtering circuit 25j determines to discard the frame (OP125). Thereafter, the flowchart of FIG. 37B ends.

In OP126, the AC filtering circuit 25j judges whether or not the VLAN AC value of the frame received from the SW circuit 2 is 010. If the VLAN AC value is 010 (YES in OP126), only user frames are to be received in the VLAN to which the frame received from the SW circuit 2 belongs. In this case, the process proceeds to OP127. If the VLAN AC value is not 010 (NO in OP126), the AC filtering circuit 25j determines to discard the frame received from the SW circuit 2 (OP129).

In OP127, the AC filtering circuit 25j judges whether or not the entry AC value included in the apparatus header of the frame received from the SW circuit 2 is 010. If the entry AC value is 010 (YES in OP127), since the frame received from the SW circuit 2 is a user frame, the AC filtering circuit 25j determines not to discard the AC filtering circuit 25j (OP128). Thereafter, the flowchart of FIG. 37B ends. If the entry AC value is not 010, that is, if it is not clearly indicated that the frame received from the SW circuit 2 is a user frame (NO in OP127), the AC filtering circuit 25j determines to discard the frame (OP129). Thereafter, the flowchart of FIG. 37B ends.

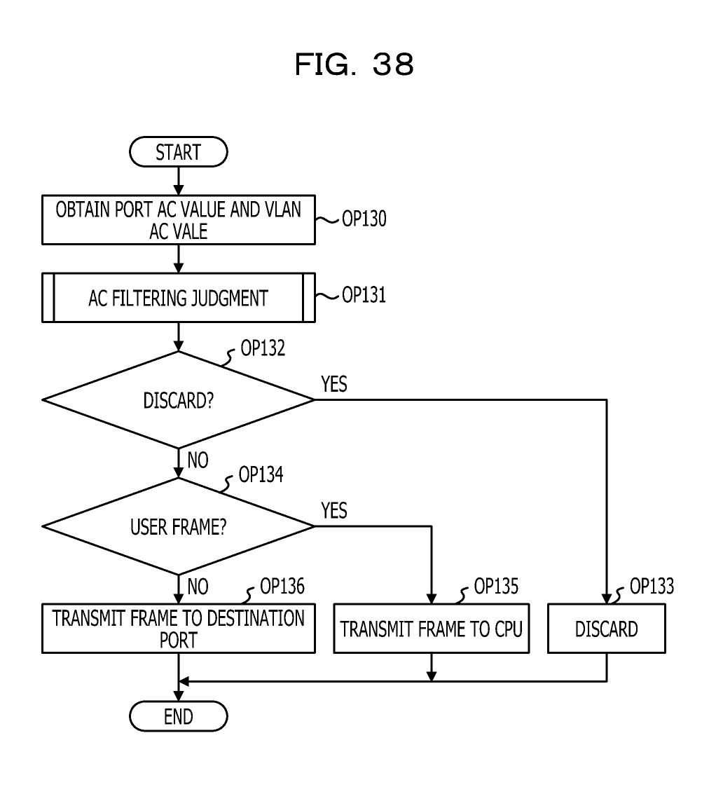

FIG. 38 is a flowchart illustrating an example of a process for transmitting a frame executed by the line IF circuit 1j according to the tenth embodiment. The flowchart of FIG. 38 begins when the line IF circuit 1j has received a frame from the SW circuit 2.

In OP130, the transmission judgment circuit 26j transmits a destination port number and an entry AC value included in an apparatus header of the frame received from the SW circuit 2 and a VLAN ID included in the frame to the AC filtering circuit 25j. The AC filtering circuit 25j accesses a port AC circuit 21j using the destination port number and obtains a port AC value. The AC filtering circuit 25j accesses the VLAN AC circuit 27 using the VLAN ID and obtains the VLAN AC value. Next, the process proceeds to OP131.

In OP131, the AC filtering circuit 25j executes an AC filtering judgment process. The AC filtering judgment process is, for example, the process illustrated by the flowcharts of FIGS. 37A and 37B. The AC filtering circuit 25j transmits results of the AC filtering judgment process to the transmission judgment circuit 26j. Next, the process proceeds to OP132.

In OP132, the transmission judgment circuit 26j judges whether or not the results of the AC filtering judgment process indicate discard of the frame received from the SW circuit 2. If the results of the AC filtering judgment process indicate discard of the frame received from the SW circuit 2 (YES in OP132), the process proceeds to OP133. If the results of the AC filtering judgment process do not indicate discard of the frame received from the SW circuit 2 (NO in OP132), the process proceeds to OP134.

In OP133, since the results of the AC filtering judgment process indicate discard of the frame received from the SW circuit 2, the transmission judgment circuit 26j discards the frame. Thereafter, the flowchart of FIG. 38 ends.

In OP134, the transmission judgment circuit 26j judges whether or not the frame received from the SW circuit 2 is a user frame. This judgment may be made on the basis of the entry AC value included in the apparatus header of the frame, or may be made by judging whether or not the destination card number included in the apparatus header of the frame is the CPU 18. If the frame received from the SW circuit 2 is a user frame (YES in OP134), the process proceeds to OP135. If the frame received from the SW circuit 2 is not a user frame (NO in OP134), the process proceeds to OP136.

In OP135, since the frame received from the SW circuit 2 is a control frame, the transmission judgment circuit 26j removes the apparatus header from the frame and transmits the frame to the CPU 18. Thereafter, the flowchart of FIG. 38 ends.

In OP136, since the frame received from the SW circuit 2 is a user frame, the transmission judgment circuit 26j removes the apparatus header from the frame and transmits the frame to a port indicated by the destination port number included in the apparatus header. Thereafter, the flowchart of FIG. 38 ends.

According to the tenth embodiment, the communication apparatus 100 can also execute the packet filtering on a frame to be transmitted (a frame received by the line IF circuit 1j from the SW circuit 2). The packet filtering of a frame to be transmitted can be set just by setting the port AC value in the port AC table 22j and the VLAN AC value in the VLAN AC table 28j without adding, deleting, or changing the entries in the content-addressable memory 14 and the associative memory 16g.

In the tenth embodiment, the line IF circuit 1j may use either the port AC table 22j or the VLAN AC circuit 27. In this case, the AC filtering circuit 25j executes the AC filtering judgment process on the basis of the port AC value and the entry AC value or on the basis of the VLAN AC value and the entry AC value, in accordance with the circuit used.

The tenth embodiment may be combined with any of the seventh to ninth embodiments. When the tenth embodiment has been combined with any of the seventh to ninth embodiments, the communication apparatus 100 can execute the packet filtering on both a received frame and a frame to be transmitted. The packet filtering on both a received frame and a frame to be transmitted can be controlled using the port AC value and the VLAN AC value.

In the eleventh embodiment, as with the tenth embodiment, the communication apparatus 100 executes the AC filtering judgment process on the transmission side of a line IF circuit and loopback of user frames in units of ports or VLANs. In the eleventh embodiment, the configuration of a line IF circuit 1k is the same as that of the line IF circuit 1j according to the tenth embodiment, except for a reception judgment circuit 17k, an AC filtering circuit 25k, and a transmission judgment circuit 26k (refer to FIG. 32). In the eleventh embodiment, when a received frame is to be transmitted, the reception judgment circuit 17k adds, to an apparatus header, a reception card number and a reception port number for receiving the received frame, and an entry AC value.

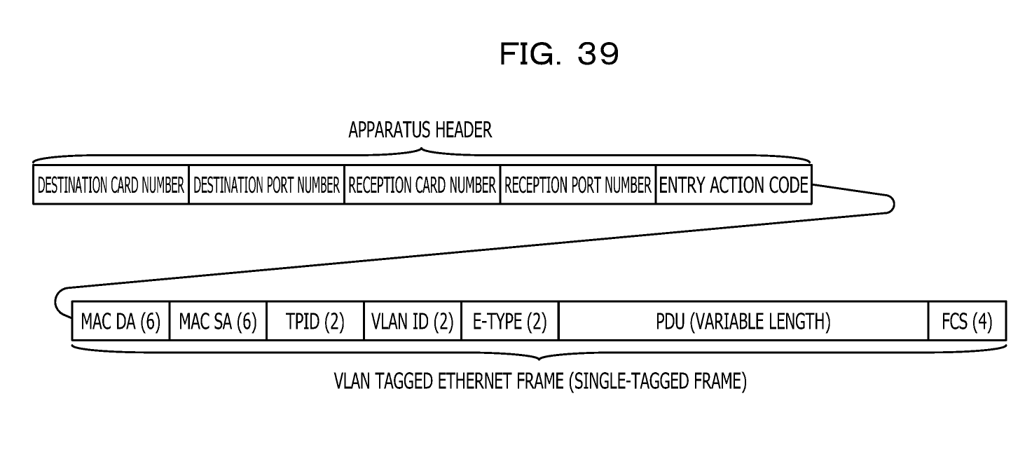

FIG. 39 is a diagram illustrating the format of an Ethernet frame to which an apparatus header according to the eleventh embodiment has been added. In the eleventh embodiment, the reception card number, the reception port number, and the entry AC value for receiving a received frame are included in the apparatus header in addition to the destination card number and the destination port number. As the destination card number, the destination port number, and the entry AC value, values included in the entry of the received frame in the associative memory 16g are used. As the reception card number of the received frame, the card number of the line IF circuit 1k itself is used. By including the reception card number and the reception port number of the received frame in the apparatus header, it is possible to notify the transmission judgment circuit 26k of the line IF circuit 1k that transmits the frame to a line of the reception card number and the reception port number. Although FIG. 39 illustrates an example in which the apparatus header has been added to a VLAN single-tagged Ethernet frame, the present disclosure is not limited to this. The apparatus header illustrated in FIG. 39 can be added to a VLAN untagged Ethernet frame or an Ethernet frame to which two or more VLAN tags have been provided.

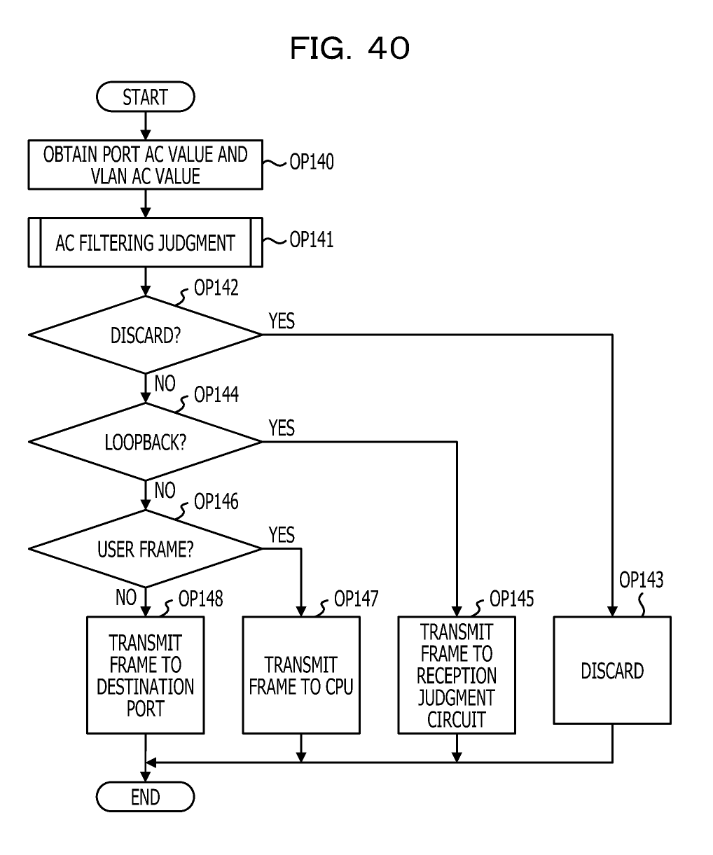

FIG. 40 is a flowchart illustrating an example of the process for transmitting a frame executed by the line IF circuit 1k according to the eleventh embodiment. The flowchart of FIG. 40 begins when the line IF circuit 1k has received a frame from the SW circuit 2.

In OP140, the transmission judgment circuit 26k transmits a destination port number and an entry AC value included in an apparatus header of the frame received from the SW circuit 2 and a VLAN ID included in the frame to the AC filtering circuit 25k. The AC filtering circuit 25k accesses the port AC circuit 21 using the destination port number and obtains a port AC value from the port AC table 22j. The AC filtering circuit 25k accesses the VLAN AC circuit 27 using the VLAN ID and obtains a VLAN AC value from the VLAN AC table 28j. Next, the process proceeds to OP141.

In OP141, the AC filtering circuit 25k executes an AC filtering judgment process. The AC filtering judgment process is, for example, the process illustrated by the flowcharts of FIGS. 33A and 33B. However, in the AC filtering judgment process executed in OP141, the entry AC value illustrated in FIGS. 33A and 33B is replaced by the entry AC value included in the apparatus header of the frame received from the SW circuit 2. The port AC value is replaced by the port AC value of a destination port indicated by the apparatus header of the frame received from the SW circuit 2. The AC filtering circuit 25k transmits results of the AC filtering judgment process to the transmission judgment circuit 26k. Next, the process proceeds to OP142.

In OP142, the transmission judgment circuit 26k judges whether or not the results of the AC filtering judgment process indicate discard of the frame received from the SW circuit 2. If the results of the AC filtering judgment process indicate discard of the frame received from the SW circuit 2 (YES in OP142), the process proceeds to OP143. If the results of the AC filtering judgment process do not indicate discard of the frame received from the SW circuit 2 (NO in OP142), the process proceeds to OP144.

In OP143, since the results of the AC filtering judgment process indicate discard of the frame received from the SW circuit 2, the transmission judgment circuit 26k discards the frame. Thereafter, the flowchart of FIG. 40 ends.

In OP144, the transmission judgment circuit 26k judges whether or not the results of the AC filtering indicate loopback of the frame received from the SW circuit 2. If the results of the AC filtering judgment process indicate loopback of the frame received from the SW circuit 2 (YES in OP144), the process proceeds to OP145. If the results of the AC filtering judgment process do not indicate loopback of the frame received from the SW circuit 2 (NO in OP144), the process proceeds to OP146.

In OP145, the transmission judgment circuit 26k transmits the frame received from the SW circuit 2 to the reception judgment circuit 17k. In the reception judgment circuit 17k, the destination card number included in the apparatus header of the received frame is overwritten by the reception card number included in the apparatus header. The destination port number included in the apparatus header of the received frame is overwritten by the reception port number included in the apparatus header. The frame whose destination card number and destination port number included in the apparatus header thereof have been overwritten is transmitted from the reception judgment circuit 17k to the SW circuit 2. Thereafter, the frame is transferred by the SW circuit 2 to the line IF circuit 1k having the reception card number and then transmitted from a reception port to a line. Thus, the loopback is realized. Thereafter, the flowchart of FIG. 40 ends.

In OP146, the transmission judgment circuit 26k judges whether or not the frame received from the SW circuit 2 is a user frame. This judgment may be made on the basis of the entry AC value included in the apparatus header of the frame or may be made by judging whether or not the destination card number included in the apparatus header of the frame is the CPU 18. If the frame received from the SW circuit 2 is a user frame (YES in OP146), the process proceeds to OP148. If the frame received from the SW circuit 2 is not a user frame, that is, if the frame received from the SW circuit 2 is a control frame (NO in OP146), the process proceeds to OP147.

In OP147, since the frame received from the SW circuit 2 is a control frame, the transmission judgment circuit 26k removes the apparatus header from the frame and transmits the frame to the CPU 18. Thereafter, the flowchart of FIG. 40 ends.

In OP148, since the frame received from the SW circuit 2 is a user frame and any of the ports of the transmission judgment circuit 26k is the destination port, the transmission judgment circuit 26k removes the apparatus header from the frame and transmits the frame to a port thereof indicated by the destination port number included in the apparatus header. Thereafter, the flowchart of FIG. 40 ends.

According to the eleventh embodiment, the communication apparatus 100 can execute loopback on a frame transmitted from the line IF circuit 1j (a frame received by the line IF circuit 1j from the SW circuit 2). In the eleventh embodiment, the line IF circuit 1k may use either the port AC circuit 21 or the VLAN AC circuit 27. In this case, the AC filtering circuit 25k executes the AC filtering judgment process on the basis of the port AC value and the entry AC value or the VLAN AC value and the entry AC value, in accordance with the circuit used.

In addition, according to the eleventh embodiment, troubleshooting can be performed using loopback control in units of ports or VLANs as a diagnostic function at the time of failure, and therefore it is possible to significantly improve the reliability of the network.

In addition, the eleventh embodiment is effective when a reception port of a card that has received a frame and a destination port of a card that serves as the destination of the frame in the communication apparatus 100 have a point-to-point connection. This is because the processing load relating to the received frame including loopback can be distributed between a line IF circuit on the reception side and a line IF circuit on the transmission side.

In a twelfth embodiment, the communication apparatus 100 executes an AC filtering judgment process both upon receiving a frame and upon transmitting a frame.

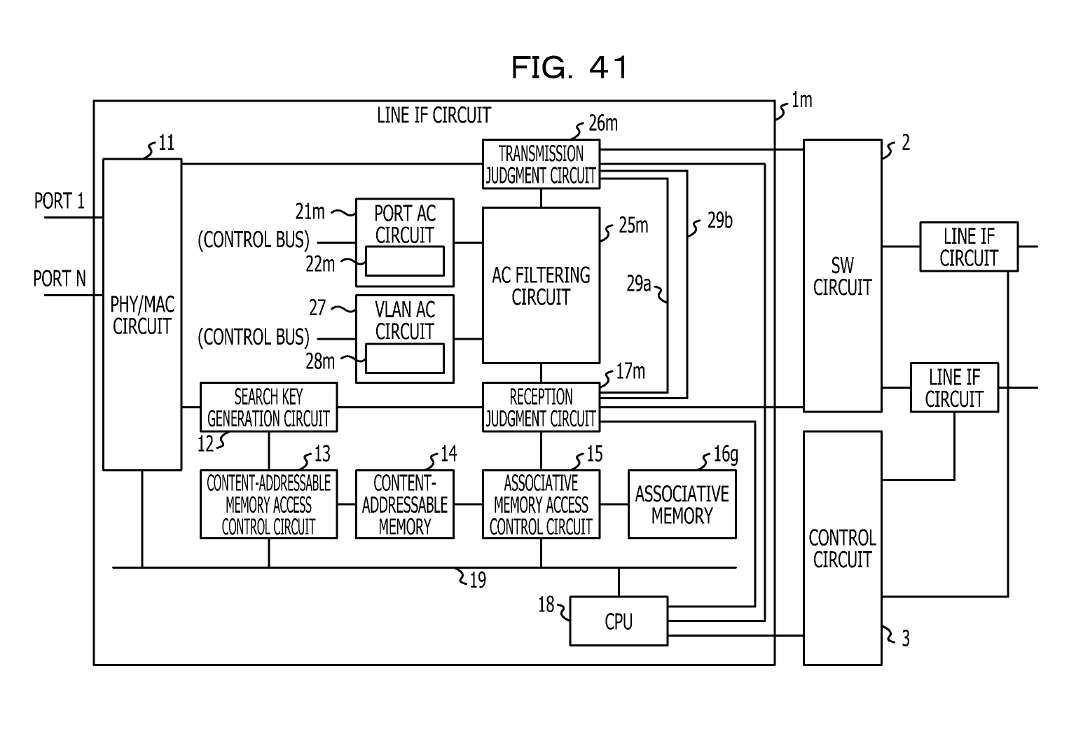

FIG. 41 is a diagram illustrating an example of a line IF circuit 1m according to the twelfth embodiment. In the twelfth embodiment, the configuration except for a reception judgment circuit 17m, an AC filtering circuit 25m, and a transmission judgment circuit 26m may be the same as that according to any of the first to eleventh embodiments. However, in the following description, the line IF circuit 1m is assumed to execute packet filtering in units of ports or VLANs.

The AC filtering circuit 25m executes the AC filtering judgment process in accordance with inputs from both the reception judgment circuit 17 and the transmission judgment circuit 26m. More specifically, when an entry of a received frame in the associative memory 16g has been input from the reception judgment circuit 17m, the AC filtering circuit 25m executes the same AC filtering judgment process as the AC filtering circuit 25i according to the ninth embodiment. When a destination port number and an entry AC value included in an apparatus header of the frame and a VLAN ID included in the frame have been input from the transmission judgment circuit 26m, the AC filtering circuit 25m executes the same AC filtering judgment process as the AC filtering circuit 25k according to the eleventh embodiment.

When the frame is to be looped back as a result of the AC filtering judgment process, the reception judgment circuit 17m and the transmission judgment circuit 26m are coupled by signal lines 29a and 29b, which serve as routes for the loopback. For example, when it has been judged upon receiving a frame that the received frame is to be looped back, the signal line 29a serves as a route for the reception judgment circuit 17m to transmit the received frame to the transmission judgment circuit 26m. For example, when it has been judged upon receiving a frame from the SW circuit 2 that the frame is to be looped back, the signal line 29b serves as a route for the transmission judgment circuit 26m to transmit the frame to the reception judgment circuit 17m.

Upon receiving a frame from the signal line 29a, which serves as a route for loopback, the transmission judgment circuit 26m does not transmit the frame to the AC filtering circuit 25m for the AC filtering judgment process but transmits the frame to a destination port indicated by the apparatus header. That is, the target of the AC filtering judgment process in the process for transmitting a frame is a frame received by the transmission judgment circuit 26m from the SW circuit 2.

Upon receiving a frame from the signal line 29b, which serves as a route for loopback, the reception judgment circuit 17m does not transmit the frame to the AC filtering circuit 25m for the AC filtering judgment process but transmits the frame to the SW circuit 2. That is, in the process for receiving a frame, a frame received by the reception judgment circuit 17m from the signal line 29b, which serves as a route for loopback, is not a target of the AC filtering judgment process. As with the reception judgment circuit 17k according the eleventh embodiment, the reception judgment circuit 17m adds an apparatus header illustrated in FIG. 39 to the frame.

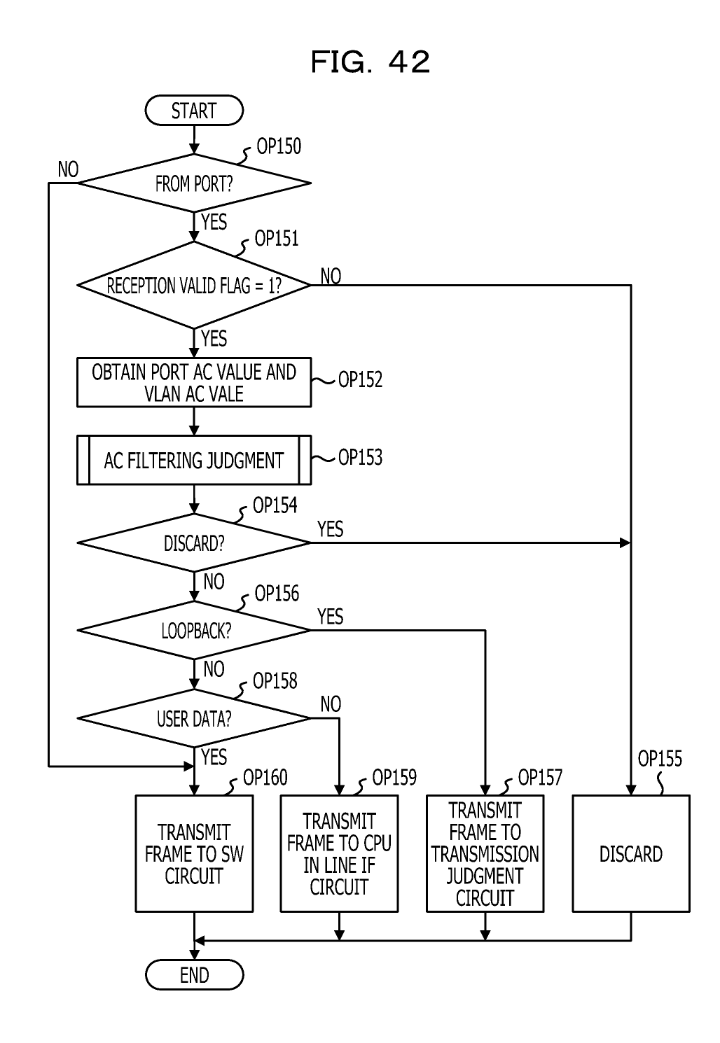

FIG. 42 is a flowchart illustrating an example of the process for receiving a frame executed by the line IF circuit 1m according to the twelfth embodiment. In FIG. 42, however, processing (for example, the processing in OP41 to OP45 illustrated in FIG. 28A) executed until a frame is input to the reception judgment circuit 17m after the frame is received by a port of the line IF circuit 1m is omitted. Therefore, in FIG. 42, the flowchart begins with reception of a frame by the reception judgment circuit 17m.

In OP150, the reception judgment circuit 17m judges whether or not the frame has been input from a port (line). In the reception judgment circuit 17m, the input route (signal line) is different between when a frame has been input from the associative memory access control circuit 15 and when a frame has been input from the transmission judgment circuit 26m. Therefore, whether or not the frame has been input from a port can be judged on the basis of the input route of the frame. If the frame has been input from a line (YES in OP150), the process proceeds to OP151.

In OP151, since the frame has been input from a port (line), the frame becomes a target of the AC filtering judgment process in the process for receiving a frame. Therefore, the AC filtering judgment process is executed on the frame. Processing in OP151 to OP160 is the same as the processing in OP46 to OP56 illustrated in FIGS. 28A and 28B, and accordingly description thereof is omitted. The frame is processed in accordance with results of the AC filtering judgment process.

If the frame has not been input from a port (line) (NO in OP150), the frame is not a target of the AC filtering judgment process in the process for receiving a frame. Therefore, the process proceeds to OP160, and the frame is transmitted from the reception judgment circuit 17m to the SW circuit 2 (OP160). The frame that has not been input from a port (line) may be, for example, a frame looped back from the transmission judgment circuit 26m. For example, when a frame that has been looped back from the transmission judgment circuit 26m has been input, the reception judgment circuit 17m overwrites a destination card number and a destination port number included in the apparatus header using a reception card number and a reception port number included in the apparatus header. The frame is transmitted to the SW circuit 2 and transferred to a destination card indicated by the apparatus header. The destination card and the destination port indicated by the apparatus header have been overwritten by the reception judgment circuit 17m using a reception card and a reception port of the frame. Therefore, the frame is transmitted from the reception port of the reception card to a line, thereby completing loopback.

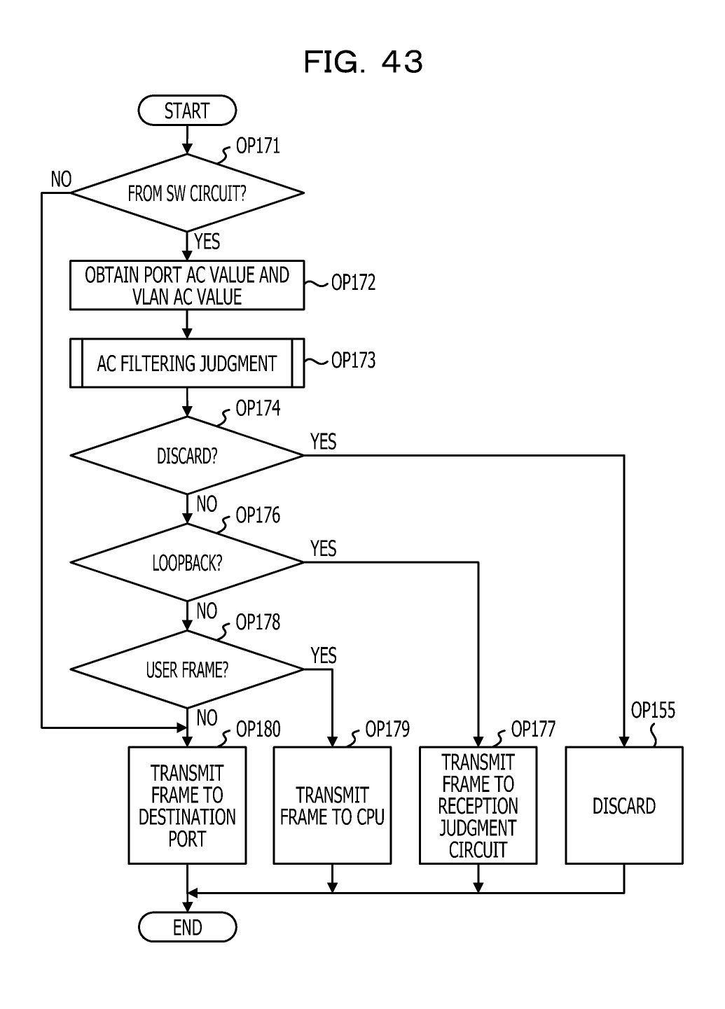

FIG. 43 is a flowchart illustrating an example of the process for transmitting a frame executed by the line IF circuit 1m according to the twelfth embodiment. The flowchart of FIG. 43 begins when the transmission judgment circuit 26 has received a frame.

In OP171, the transmission judgment circuit 26m judges whether or not the received frame is a frame received from the SW circuit 2. In the transmission judgment circuit 26m, the input route (signal line) is different between when a frame has been input from the reception judgment circuit 17m and when a frame has been input from the CPU 18. Therefore, whether or not the frame has been input from the SW circuit 2 can be judged on the basis of the input route of the frame. If the frame has been input from the SW circuit 2 (YES in OP171), the process proceeds to OP172.

In OP172, since the frame has been input from the SW circuit 2, the frame becomes a target of the AC filtering judgment process in the process for transmitting a frame. Therefore, the AC filtering judgment process is executed on the frame. Processing in OP172 to OP180 is the same as the processing in OP140 to OP148 illustrated in FIG. 40, and accordingly description thereof is omitted.

If the frame has not been input from the SW circuit 2 (NO in OP171), the frame is not a target of the AC filtering process. Therefore, the process proceeds to OP180. The frame is transmitted from the transmission judgment circuit 26m to a destination port indicated by the apparatus header and then transmitted from the destination port to a line (OP180). The frame that has not been input from the SW circuit 2 may be, for example, a frame looped back from the reception judgment circuit 17m, a frame received from the CPU 18, or the like. For example, when a frame that has been looped back from the reception judgment circuit 17m has been input to the transmission judgment circuit 26m, the frame is transferred to a destination port indicated by an apparatus header thereof. The destination card and the destination port indicated by the apparatus header have been overwritten by the reception judgment circuit 17m using a reception card and a reception port of the frame. Therefore, the frame is transmitted from the reception port of the reception card to a line, thereby completing loopback.

As described above, in the twelfth embodiment, by executing the AC filtering judgment process in both the process for receiving a frame and the process for transmitting a frame, it is possible to execute the packet filtering at a higher speed than when the AC filtering judgment process is executed in either the process for receiving a frame or the process for transmitting a frame.

In addition, in the seventh to twelfth embodiments, an AC value for specifying loopback of all frames is not set, so that loopback of control frames are not executed. As a result, it is possible to perform loopback control in units of ports or VLANs from a distance using control frames. By realizing the loopback in units of ports or VLANs, it is possible to perform troubleshooting in units of ports or VLANs as a diagnostic function at the time of failure, and therefore it is possible to significantly improve the reliability of the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An interface module comprising:
ports;
a first memory that stores identifiers indicating processing operations for data blocks while associating the identifiers with the ports;
a content-addressable memory that stores keys, each including at least one port and one identifier;
a second memory that stores processing information associated with the keys held by the content-addressable memory and indicating processing operations for data blocks in accordance with the processing operation indicated by the at least one identifier included in one of the keys with which a piece of the processing information is associated;
an action code circuit that, when a data block has been received, obtains, from the first memory, an identifier set for a port that has received the data block;
a generation circuit that generates a key from the port that has received the data block and the identifier obtained by the action code circuit; and
a judgment circuit that judges how to process the received data block in accordance with a piece of the processing information associated with the generated key obtained by searching the content-addressable memory using the key generated by the generation circuit.

2. The interface module according to claim 1,
wherein the first memory stores, for a first port, a first identifier indicating a processing operation according to a type of data block,
wherein the content-addressable memory stores a first key including the first port, the first identifier, and part of the data block, and
wherein the second memory stores a piece of the processing information associated with the first key.

3. The interface module according to claim 1,
wherein the first memory stores, for a second port, a second identifier indicating that a data block received by the second port is to be transmitted from the second port,
wherein the content-addressable memory stores a second key including the second port and the second identifier,
wherein the second memory stores second processing information indicating that data blocks are not to be discarded and destination information indicating the second port as an output port of the data blocks while associating the second processing information and the destination information with the second key, and
wherein, when the second port has received a data block, the judgment circuit determines to transmit the data block from the second port in accordance with the destination information.

4. The interface module according to claim 1, further comprising:
a counter circuit that counts the number of data blocks received that match the keys held by the content-addressable memory.

5. An interface module comprising:
ports;
a first memory that stores identifiers indicating processing operations for data blocks while associating the identifiers with the ports;
an action code circuit that, when a data block is to be transmitted or received, obtains, from the first memory, one of the identifiers set for a port that is to transmit or receive the data block; and
a judgment circuit that determines how to process the data block on the basis of the identifier obtained by the action code circuit.

6. The interface module according to claim 5, further comprising:
a content-addressable memory that stores keys, each including a port and part of a data block;
a second memory that stores type information indicating types of data blocks with which the keys held by the content-addressable memory are associated; and
a generation circuit that, when a data block has been received, generates a key from a port that has received the data block and part of the received data block,
wherein the judgment circuit determines how to process the received data block on the basis of the type information that matches the key generated by the generation circuit obtained by searching the content-addressable memory using the key generated by the generation circuit and the identifier obtained by the action code circuit.

7. The interface module according to claim 5, further comprising:
a second memory that stores second identifiers indicating processing operations for data blocks for virtual groups,
wherein, when a data block is to be transmitted or received, the action code circuit obtains, from the second memory, one of the second identifiers set for one of the virtual groups to which the data block belongs, and
wherein the judgment circuit determines how to process the data block on the basis of the second identifier obtained by the action code circuit.

8. The interface module according to claim 5, further comprising:
a content-addressable memory that stores keys, each including a port and part of a data block;
a second memory that stores type information indicating types of data blocks with which the keys held by the content-addressable memory are associated;
a generation circuit that, when a data block has been received, generates a key from a port that has received the data block and part of the received data block; and
a reception processing circuit that adds the type information obtained by searching the content-addressable memory using the key generated by the generation circuit to the received data block and that transmits the received data block to a switch circuit,
wherein, upon receiving the data block to which the type information has been added from the switch circuit, the judgment circuit determines how to process the received data block on the basis of the type information added to the data block and the identifier obtained by the action code circuit.

9. A communication apparatus comprising:
a plurality of interfaces modules, each including
ports,
a first memory that stores identifiers indicating processing operations for data blocks while associating the identifiers with the ports;
a content-addressable memory that stores keys, each including at least one port and one identifier,
a second memory that stores processing information associated with the keys held by the content-addressable memory and indicating processing operations for data blocks in accordance with the processing operation indicated by the at least one identifier included in one of the keys with which a piece of the processing information is associated,
an action code circuit that, when a data block has been received, obtains, from the first memory, an identifier set for a port that has received the data block, and
a generation circuit that generates a key from the port that has received the data block and the identifier obtained by the action code circuit, and
a judgment circuit that determines how to process the received data block in accordance with a piece of the processing information associated with the generated key obtained by searching the content-addressable memory using the key generated by the generation circuit; and
a switch circuit that relays a data block between the plurality of interface modules.

10. A communication method used by an interface module including
ports,
a first memory that stores identifiers indicating processing operations for data blocks while associating the identifiers with the ports,
a content-addressable memory that stores keys, each including at least one port and one identifier, and
a second memory that stores processing information associated with the keys held by the content-addressable memory and indicating processing operations for data blocks in accordance with the processing operation indicated by the at least one identifier included in one of the keys with which a piece of the processing information is associated, the communication method comprising:
obtaining, when a data block has been received, an identifier set for a port that has received the data block from the first memory;
generating a key from the port that has received the data block and the obtained identifier; and
determining how to process the received data block in accordance with a piece of the processing information obtained by searching the content-addressable memory using the generated key.
